(19) United States
(12) Patent Application Publication
(10) Pub. No.: US 2016/0169454 A1
(43) Pub. Date: Jun. 16, 2016

(54) LIGHT EMITTING DIODE APPARATUS, SYSTEM, AND METHOD

(71) Applicant: NUWAVE LLC, Libertyville, IL (US)

(72) Inventors: Jung Sik Moon, Long Grove, IL (US); Eung Yub Cha, Glenview, IL (US); Eunjung Huh, Gurnee, IL (US)

(73) Assignee: NUWAVE LLC, Libertyville, IL (US)

(21) Appl. No.: 14/799,456

(22) Filed: Jul. 14, 2015

Related U.S. Application Data
(63) Continuation-in-part of application No. 29/484,775, filed on Mar. 12, 2014.
(60) Provisional application No. 62/024,467, filed on Jul. 15, 2014.

(51) Int. Cl. F21K 99/00; B29C 70/80; F21V 29/503; F21V 29/70; H05B 33/08; H05B 37/02

(52) U.S. Cl. CPC F21K 9/13; H05B 33/0845; H05B 37/0272; F21K 9/17; F21V 29/503; F21V 29/70; B29C 70/80; F21Y 2101/02; F21Y 2103/003

(57) ABSTRACT

This patent discloses various exemplary light emitting diode (LED) bulb apparatus, systems and methods, including features isolating electrical components.

### CROSS-REFERENCE TO RELATED APPLICATIONS

This application is a US Provisional Utility patent application, and is a continuation-in-part of, and claims priority under 35 USC Section 120 of U.S. Design patent application Ser. No. 29/484,775, filed Mar. 12, 2014, entitled “Light Bulb,” the contents of which is incorporated herein by reference in its entirety.

### BACKGROUND OF THE INVENTION

1. Field of the Invention

The present invention relates generally to illumination devices, and more particularly to a light emitting diode (LED) bulb, wherein the LED bulb has various improvements over conventional light bulbs.

2. Related Art

LEDs are solid state light emitting devices formed of semiconductors, which are more stable and reliable than other conventional light sources such as incandescent bulbs. LEDs are conventionally widely used in various fields such as alphanumeric display elements, signal lights, light sources for lighting, and display devices.

A conventional LED bulb includes a holder or holding plate, a substrate located at one end of the holder and a plurality of LEDs mounted on a typically planar mounting face of the substrate. Light distribution of conventional LED bulbs is mostly concentrated at a center axis while gradually weakening towards a periphery of the conventional LED bulb.

When the plurality of LEDs are arranged on the planar, light may be produced in typically one direction, which may result in uneven light intensity distribution. What is needed is an improved LED bulb which can overcome shortcomings of conventional light sources.

### SUMMARY OF THE INVENTION

The present invention sets forth a light emitting diode (LED) lighting source apparatus, system and method.

According to an exemplary embodiment, a light emitting diode (LED) bulb may include: a socket; a power driver electrically coupled to said socket; an LED plate comprising a plurality of LEDs, electrically coupled to said power driver; a holding plate adapted to dissipate heat from said LED plate; and a cover.

According to one exemplary embodiment, the LED bulb may include where said power driver may include an isolated power driver.

According to one exemplary embodiment, the LED bulb may include where the isolated power driver may include: a plastic housing isolating conductive components from contact with metal components, or a user of the LED bulb.

According to one exemplary embodiment, the LED bulb may further include a silicone cavity filling of any air pockets of the LED bulb so as to prevent movement of components an wires to reduce or eliminate shock risk.

According to one exemplary embodiment, the LED bulb may include where the holding plate may include at least one fin.

According to one exemplary embodiment, the LED bulb may include where the holding plate may include a solid aluminum plate with no air gap, surrounding the LED plate.

According to one exemplary embodiment, the LED bulb may include where the LED bulb may include at least one of: a desk lamp bulb; a vanity bulb; a tube bulb; a flood light bulb; a candle bulb; an omnidirectional bulb; a globe shaped bulb; a cylindrical tub shaped bulb; a globe shaped cover bulb; or a omnidirectional bulb comprising a concavity.

According to one exemplary embodiment, the LED bulb may further include a pulse width modulation (PWM) dimming method.

According to one exemplary embodiment, the LED bulb may include where the PWM dimming method is configured to dim between 0-100 in up to 20% increments of granularity.

According to one exemplary embodiment, the LED bulb may include where the PWM dimming method is configured to dim between 0-100 in 1% increments of granularity.

According to one exemplary embodiment, the LED bulb may include where a wireless gateway wirelessly coupled to the LED bulb.

According to one exemplary embodiment, the LED bulb may include where the wireless gateway communicates with the LED bulb by at least one of: a wireless fidelity (WiFi) protocol; a bluetooth protocol; a broadband over powerline (BPL) communication method; a cable television connection; or a zigbee protocol.

According to one exemplary embodiment, the LED bulb may further include at least one of: a remote control device configured to communicate with said wireless gateway; a smartphone device and application program configured to communicate with said wireless gateway.

According to one exemplary embodiment, the LED bulb may further include an inverter configured to transform alternating current power to direct current power.

According to one exemplary embodiment, the LED bulb may include where the LED bulb is configured to reduce or eliminate risk of shock by isolating the all electronic components on the AC side of said inverter.

According to one exemplary embodiment, the LED bulb may further include at least one of: a light sensor; a luminance sensor; a daylight harvesting device; or a sensor.

According to one exemplary embodiment, the LED bulb may further include a diffuser at least one of inside, or outside of, the cover of the LED bulb.

According to one exemplary embodiment, the LED bulb may further include a reflector inside the LED bulb.

According to one exemplary embodiment, the LED bulb may further include a one-piece heat dissipation device where there is no space between the LED plate and a heat sink.

According to one exemplary embodiment, the LED bulb may include where the LED plate is slightly below said holding plate, and touches said LED plate directly to facilitate directly dissipating heat.

According to one exemplary embodiment, the LED bulb may include where the bulb is at least one of: weatherproof; or waterproof.

According to one exemplary embodiment, the LED bulb may include where the cover reflects and directs light 225 degrees without reflective material.

According to one exemplary embodiment, the LED bulb may include where the diffuser comprises a pyramid shaped plastic.

According to one exemplary embodiment, the LED bulb may include where the reflector comprises: an annular ring; and a truncated cone coupled to said annular ring.

According to one exemplary embodiment, the LED bulb may further include a plastic housing.

According to one exemplary embodiment, the LED bulb may include where the plastic housing comprises a bell-shaped cone.

According to one exemplary embodiment, the LED bulb may include where the cover comprises at least one of: glass; plastic; or silicone.

According to one exemplary embodiment, the LED bulb may include where the holding plate comprises at least one of: aluminum; or metal.

According to one exemplary embodiment, the LED bulb may further include empty space below the LED plate inside the LED bulb to facilitate heat dissipation.

According to one exemplary embodiment, a method of making an LED bulb may include: filling an air pocket of an LED bulb with silicone rubber; and allowing said silicone rubber to set.

### BRIEF DESCRIPTION OF THE DRAWINGS

FIG. 1 is an exemplary isometric perspective view of an exemplary candle lighting source or bulb, with an exemplary standard light socket, according to an exemplary embodiment of the present invention;

FIG. 2 is an exemplary bottom orthographic view of the exemplary candle light bulb according to an exemplary embodiment of the present invention;

FIG. 3 is an exemplary side orthographic view of the exemplary candle light bulb according to an exemplary embodiment of the present invention;

FIG. 4 is an exemplary side orthographic view of the exemplary candle light bulb with exemplary nonlimiting dimensions according to an exemplary embodiment of the present invention;

FIG. 5 is an exemplary orthographic top view of the exemplary candle light bulb according to an exemplary embodiment of the present invention;

FIG. 6A is an exemplary partial cutaway cross-sectional view of the exemplary candle light bulb with standard socket size, illustrating an exemplary cavity for holding an exemplary electronic printed circuit board (PCB) and exemplary drive circuitry for driving LEDs of the LED plate, according to the exemplary embodiment of the present invention;

FIG. 6B depicts an exemplary embodiment of a candle with exemplary glass or plastic cover removed illustrating an exemplary diffuser, similar to the exemplary diffuser described further with reference to FIG. 12 below, according to an exemplary embodiment;

FIG. 6C depicts an exemplary standard socket candle bulb, of exemplary 350 lumen brightness, 3.5 watt energy usage, 3000K color temperature, E12 candle socket size, and/or E13, and/or E26, etc., 36.5 year lifetime based on 3 hours of usage per day, 35-40 watt incandescent bulb replacement, according to an exemplary embodiment;

FIG. 7 is an exemplary isometric perspective view of an exemplary narrow socket candle light bulb according to an exemplary embodiment of the present invention;

FIG. 8 is an exemplary bottom orthographic view of the exemplary narrow candle socket candle LED light bulb according to an exemplary embodiment of the present invention;

FIG. 9 is an exemplary side orthographic view of the exemplary narrow candle socket candle LED light bulb according to an exemplary embodiment of the present invention;

FIG. 10 is an exemplary side orthographic view of the narrow candle socket candle LED light bulb with exemplary nonlimiting dimensions according to an exemplary embodiment of the present invention;

FIG. 11 is an exemplary top orthographic view of the exemplary narrow candle socket candle LED light bulb according to an exemplary embodiment of the present invention;

FIG. 12A is an exemplary partial cutaway cross-section view of the exemplary narrow socket candle light bulb according to an exemplary embodiment of the present invention;

FIG. 12B depicts an exemplary embodiment of a candle with exemplary glass or plastic cover removed illustrating an exemplary diffuser, according to an exemplary embodiment;

FIG. 12C depicts an exemplary side view of an exemplary embodiment of a candle with exemplary glass or plastic cover removed, illustrating an exemplary diffuser in side view illustrating one of a pair of screw couplings, according to an exemplary embodiment;

FIG. 12D depicts another exemplary side view of the exemplary embodiment of a candle with exemplary glass or plastic cover removed, illustrating a front side view orthogonal to the side view of FIG. 12C, of the exemplary diffuser with a pacifier shaped side view, illustrating the pair of screws coupling the exemplary diffuser to the exemplary LED planar plate, with an exemplary spacing between the diffuser and LED planar, according to an exemplary embodiment;

FIG. 12E depicts an exemplary top view of the exemplary embodiment of a candle with exemplary glass or plastic cover removed, illustrating a top view orthogonal to the side view of FIGS. 12C and 12D, of the exemplary diffuser, having an exemplary pyramid with concave sides shape, having an x-top view, illustrating the pair of screws coupling the exemplary diffuser to the exemplary LED planar plate, surrounded by an exemplary holding plate according to an exemplary embodiment;

FIG. 12F depicts an exemplary candle socket candle bulb, of exemplary 350 lumen brightness, 3.5 watt energy usage, 3000K color temperature, E12 candle socket size, 36.5 year lifetime based on 3 hours of usage per day, 35-40 watt incandescent bulb replacement, according to an exemplary embodiment;

FIG. 12G depicts an isolated power driver circuit for an exemplary candle LED bulb, according to an exemplary embodiment;

FIG. 12H depicts an exemplary top view of the LED printed circuit board for an exemplary 8 LED candle LED planar plate, according to an exemplary embodiment;

FIG. 12I depicts an exemplary bottom view of the LED printed circuit board for an exemplary 8 LED candle LED planar plate, according to an exemplary embodiment;

FIG. 12J depicts an isolated power driver circuit for an exemplary candle LED bulb with an E26 socket, according to an exemplary embodiment;

FIG. 13 is an exemplary isometric perspective view of an exemplary desk light bulb according to an exemplary embodiment of the present invention;

FIG. 14 is an exemplary bottom orthographic view of the exemplary desk light bulb according to an exemplary embodiment of the present invention;

FIG. 15 is an exemplary side orthographic view of the exemplary desk light bulb according to an exemplary embodiment of the present invention;

FIG. 16 is an exemplary side orthographic view of the exemplary desk light bulb with exemplary nonlimiting dimensions according to an exemplary embodiment of the present invention;

FIG. 17 is an exemplary top orthographic view of the exemplary desk light bulb according to an exemplary embodiment of the present invention;

FIG. 18 is an exemplary isometric partial cutaway section view of the exemplary desk light bulb according to an exemplary embodiment of the present invention;

FIG. 19A is an exemplary partial cross-section view of the exemplary desk globe light bulb, which may in an exemplary embodiment include 400 Lumens brightness, 4 watts of energy usage, a color temperature of 3000K, a standard E26 socket size, a lifetime of 36.5 years based on 3 hours of usage each day, replacement for a 40 watt incandescent bulb, according to an exemplary embodiment of the present invention;

FIG. 19B depicts an exemplary top view of an exemplary embodiment of the exemplary desk light with cover removed illustrating an exemplary LED plate coupled by screws to an exemplary Aluminum holding plate, according to an exemplary embodiment;

FIG. 19C depicts an exemplary side view of an exemplary embodiment of the exemplary desk light with cover removed illustrating an exemplary aluminum holding plate and an exemplary plastic exterior portion, according to an exemplary embodiment;

FIG. 19D depicts an exemplary embodiment of the exemplary desk light with standard screw electric contact, an exemplary cover, attached illustrating an exemplary substantially spherically shaped portion comprising the exemplary aluminum holding plate and exemplary glass or plastic cover, which may be coated with an exemplary silicone coating, according to an exemplary embodiment;

FIG. 19E depicts an exemplary isolated power driver, which advantageously reduces or eliminates a risk of a shock hazard, according to an exemplary embodiment of the present invention;

FIG. 20 is an exemplary isometric perspective view of an exemplary flood light bulb to an exemplary embodiment of the present invention;

FIG. 21 is an exemplary bottom orthographic view of the exemplary flood light bulb according to an exemplary embodiment of the present invention;

FIG. 22 is an exemplary side orthographic view of the exemplary flood light bulb according to an exemplary embodiment of the present invention;

FIG. 23 is an exemplary side view of the exemplary flood light bulb with exemplary nonlimiting dimensions according to an exemplary embodiment of the present invention;

FIG. 24 is an exemplary top orthographic view of the exemplary flood light bulb 2400 according to an exemplary embodiment of the present invention;

FIG. 25 is an exemplary partial cross-section view of the exemplary flood light bulb according to an exemplary embodiment of the present invention;

FIG. 26A is an exemplary partial cutaway isometric section view of the exemplary flood light bulb, illustrating the solid holding plate of one exemplary embodiment, according to an exemplary embodiment of the present invention;

FIG. 26B depicts an isolated power driver, according to an exemplary embodiment of the present invention;

FIG. 26C depicts an exemplary top view of an exemplary flood light LED planar plate, according to an exemplary embodiment;

FIG. 26D1 depicts an exemplary top view of an exemplary printed circuit board for an exemplary globe LED light, according to an exemplary embodiment;

FIG. 26D2 depicts an exemplary top view of an exemplary printed circuit board for an exemplary globe LED light, according to an exemplary embodiment;

FIG. 26E depicts an exemplary embodiment of an exemplary disassembled flood light bulb comprising an exemplary aluminum holding plate, an exemplary plastic exterior conical bell shaped body, exemplary socket, LED planar plate, exemplary plastic annular conical funnel from a top view, and exemplary plastic or glass cover according to an exemplary embodiment of the present invention;

FIG. 26F depicts an exemplary embodiment of an exemplary assembled flood light bulb comprising an exemplary aluminum holding plate, an exemplary plastic exterior conical bell shaped body, exemplary socket, exemplary heat dissipation fin(s), and exemplary plastic or glass cover 2608 according to an exemplary embodiment of the present invention;

FIG. 26G depicts an exemplary embodiment of an exemplary disassembled flood light bulb of FIG. 26E comprising an exemplary aluminum holding plate, an exemplary plastic exterior conical bell shaped body, exemplary socket, exemplary heat dissipation fin(s), exemplary plastic annular conical funnel from a bottom view, and exemplary plastic or glass cover according to an exemplary embodiment of the present invention;

FIG. 26H depicts an exemplary embodiment of an exemplary disassembled flood light bulb of FIG. 26E comprising an exemplary aluminum holding plate from a top view, including one or more internal rib(s), forming spaces about the LED plate, in one embodiment, an exemplary plastic exterior conical bell shaped body, exemplary socket, exemplary plastic annular conical funnel from a bottom view, and exemplary plastic or glass cover according to an exemplary embodiment of the present invention;

FIG. 26I depicts an exemplary top view of an exemplary embodiment of an exemplary disassembled flood light bulb of FIG. 26E comprising power supply wires for providing power from the socket up to the LED plate, according to an exemplary embodiment of the present invention;

FIG. 26J depicts an exemplary top view of an exemplary embodiment of an exemplary disassembled flood light bulb of FIG. 26E comprising screws holding the LED planar plate to the holding plate, and with exemplary plastic annular conical funnel plastic reflector surrounding LED plate, according to an exemplary embodiment of the present invention;

FIGS. 26K and 26L depict alternative embodiments of alternative holding plate inner structures as may be used in alternative embodiments of various bulbs, according to other exemplary embodiments of the present invention;

FIG. 27 is an exemplary isometric perspective view of another exemplary flood light bulb according to an exemplary embodiment of the present invention;

FIG. 28 is an exemplary bottom orthographic view of the other exemplary flood light bulb according to an exemplary embodiment of the present invention;

FIG. 29 is an exemplary side orthographic view of the other exemplary flood light bulb according to an exemplary embodiment of the present invention;

FIG. 30 is an exemplary side orthographic view of the other exemplary flood light bulb with exemplary nonlimiting dimensions according to an exemplary embodiment of the present invention;

FIG. 31A is an exemplary top orthographic view of the other exemplary flood light bulb according to an exemplary embodiment of the present invention;

FIG. 31B is a top view of an exemplary LED package layout for an exemplary flood light bulb according to an exemplary embodiment;

FIG. 32 is an exemplary partial cross-section view of the other exemplary flood light bulb according to an exemplary embodiment of the present invention;

FIG. 33A is an exemplary isometric partial cutaway section view of the exemplary other flood light bulb according to an exemplary embodiment of the present invention;

FIG. 33B depicts an exemplary schematic diagram of an exemplary isolated power driver circuit, according to an exemplary embodiment;

FIG. 33C depicts an exemplary embodiment of an exemplary disassembled flood light bulb comprising an exemplary aluminum holding plate, an exemplary plastic exterior conical bell shaped body 3310 (not shown in this view), exemplary socket (not shown in this view), exemplary LED planar plate, exemplary plastic annular conical funnel from a top view, and exemplary plastic or glass cover according to an exemplary embodiment of the present invention;

FIG. 33D depicts an exemplary embodiment of an exemplary disassembled flood light bulb of FIG. 26E comprising an exemplary aluminum holding plate, exemplary plastic annular and conical funnel from a bottom view, and exemplary plastic or glass cover according to an exemplary embodiment of the present invention;

FIG. 33E depicts exemplary Aluminum holding plate including solid portion, which advantageously leaves no gap or spacing between the LED plate and the holding plate, according to one exemplary embodiment;

FIG. 33F depicts the LED flood light bulb with the exemplary plastic annular conical funnel placed atop the holding plate, according to an exemplary embodiment;

FIG. 33G depicts an exemplary flood light bulb in assembled view with exemplary brightness of 1050 lumens, with exemplary energy usage of 11 watts, a color temperature of 3000K, an E26 standard socket size, a 36.5 year lifetime with 3 hours of usage per day, and a 100 watt incandescent bulb replacement, according to an exemplary embodiment;

FIG. 33H depicts an exploded view of an exemplary embodiment of the flood light bulb including exemplary cover, internal reflector, Aluminum LED plate board, Aluminum heat sink holding plate, power driver, plastic housing, and standard E26 socket base, according to an exemplary embodiment;

FIG. 33I depicts the exemplary embodiment of FIG. 33H assembled, according to an exemplary embodiment;

FIG. 33J depicts an exemplary bottom view of an exemplary LED plate as may be used in an exemplary flood light of an exemplary embodiment of the present invention;

FIG. 33K depicts an exemplary top view of an exemplary LED plate as may be used in an exemplary flood light of an exemplary embodiment of the present invention;

FIG. 34 is an exemplary bottom orthographic view of an exemplary vanity light bulb of FIG. 35 according to an exemplary embodiment of the present invention;

FIG. 35 is an exemplary side orthographic view of an exemplary vanity light bulb according to an exemplary embodiment of the present invention;

FIG. 36 is an exemplary side orthographic view of the exemplary vanity light bulb with exemplary nonlimiting dimensions according to an exemplary embodiment of the present invention;

FIG. 37 is an exemplary top orthographic view of the exemplary vanity light bulb according to an exemplary embodiment of the present invention;

FIG. 38 is an exemplary partial cutaway cross-section view of the exemplary vanity light bulb according to an exemplary embodiment of the present invention;

FIG. 39 is an exemplary isometric partial cutaway cross-section view of the exemplary vanity light bulb according to an exemplary embodiment of the present invention;

FIG. 40A is an exemplary isometric perspective view of the exemplary vanity light bulb according to an exemplary embodiment of the present invention;

FIG. 40B depicts an exemplary view of the exemplary embodiment of the exemplary vanity light bulb with exemplary glass or plastic cover removed, illustrating a circular LED plate, an exemplary diffuser, illustrating the pair of screws coupling the exemplary diffuser to the exemplary LED planar plate, according to an exemplary embodiment;

FIG. 40C depicts an exemplary assembled view of the exemplary vanity light bulb of exemplary brightness 350 lumens, 4 watts energy usage, color temperature of 3000K, standard socket size E26, a 36.5 year lifetime based on 3 hours per day usage, 40 watt lightbulb replacement, according to an exemplary embodiment;

FIG. 40D depict an exemplary orthographic top view of an exemplary diffuser, with exemplary dimensions, according to an exemplary embodiment;

FIG. 40E depict an exemplary orthographic front view of an exemplary diffuser, with exemplary dimensions, according to an exemplary embodiment;

FIG. 40F depict an exemplary orthographic side view of an exemplary diffuser, with exemplary dimensions, according to an exemplary embodiment;

FIG. 40G depict an exemplary exploded view of an exemplary LED bulb, with exemplary dimensions, according to an exemplary embodiment;

FIG. 40H depicts an exemplary isolated power driver according to an exemplary embodiment;

FIG. 40I depicts an exemplary bottom view of an exemplary embodiment of an exemplary LED plate for an exemplary vanity bulb, according to an exemplary embodiment;

FIG. 40J depicts an exemplary top view of an exemplary embodiment of an exemplary LED plate for an exemplary vanity bulb, according to an exemplary embodiment;

FIG. 41 is an exemplary bottom orthographic view of the exemplary other flood light bulb shown in FIG. 30, according to an exemplary embodiment of the present invention;

FIG. 42 is a side orthographic view of a globe light bulb according to an exemplary embodiment of the present invention;

FIG. 43 is a side orthographic view of the globe light bulb with exemplary nonlimiting dimensions according to an exemplary embodiment of the present invention;

FIG. 44A is an isometric perspective view of the globe light bulb according to an exemplary embodiment of the present invention;

FIG. 44B depicts an exemplary schematic drawing of an example isolated power driver according to an exemplary embodiment;

FIG. 44C depicts an exemplary top view of an exemplary LED plate for an exemplary globe bulb according to an exemplary embodiment;

FIG. 44D1 depicts an exemplary embodiment of a top side of the an exemplary LED plate for an exemplary globe, according to an exemplary embodiment;

FIG. 44D2 depicts an exemplary embodiment of a bottom side of the an exemplary LED plate for an exemplary globe, according to an exemplary embodiment;

FIG. 44E depicts a schematic diagram of th exemplary

FIG. 45A is a top orthographic view of the globe light bulb according to an exemplary embodiment of the present invention;

FIG. 45B is a top view of an exemplary LED package layout for an exemplary globe light bulb according to an exemplary embodiment;

FIG. 45C is an exemplary isolated power driver circuit according to an exemplary embodiment;

FIG. 45D is an exemplary top view of an exemplary LED plate for an exemplary omni bulb (aka all purpose bulb or light), according to an exemplary embodiment;

FIG. 45E1 is an exemplary top view of the power driver, according to an exemplary embodiment;

FIG. 45E2 is an exemplary bottom view of the power driver, according to an exemplary embodiment;

FIG. 46 is an exemplary partial cutaway cross-section view of the exemplary globe light bulb according to an exemplary embodiment of the present invention;

FIG. 47 is an exemplary bottom orthographic view of the exemplary globe light bulb according to an exemplary embodiment of the present invention;

FIG. 48 is an exemplary side orthographic view of an exemplary omni globe light bulb according to an exemplary embodiment of the present invention;

FIG. 49 is an exemplary side orthographic view of the omni globe light bulb with exemplary nonlimiting dimensions according to an exemplary embodiment of the present invention;

FIG. 50A is an exemplary embodiment of an isometric perspective view of the omni globe light bulb according to an exemplary embodiment of the present invention;

FIG. 50A depicts an exemplary isometric view of an exemplary omni light bulb, according to an exemplary embodiment;

FIG. 51A is a top orthographic view of the omni globe light bulb according to an exemplary embodiment of the present invention;

FIG. 51B is a top view of an exemplary LED package layout for an exemplary omni globe light bulb according to an exemplary embodiment;

FIG. 52 is an exemplary partial cutaway cross-section view of the omni globe light bulb according to an exemplary embodiment of the present invention;

FIG. 53A depicts an exemplary embodiment of an exemplary tube light, disassembled to allow viewing of exemplary components, including, e.g., but not limited to, exemplary first end and second end, and/or sideboard, including LED board (shown in FIG. 53B), according to an exemplary embodiment;

FIG. 53B depicts an exemplary embodiment of the exemplary tube light of FIG. 53A, disassembled to allow viewing of exemplary components, including, e.g., but not limited to, LED board, disassembled from exemplary sideboard, according to an exemplary embodiment;

FIG. 53C depicts an exemplary embodiment of the exemplary tube light of FIG. 53A, disassembled to allow viewing of exemplary components, including, e.g., but not limited to, LED board, disassembled from exemplary sideboard, according to an exemplary embodiment;

FIG. 53D depicts an exemplary embodiment of the exemplary tube light of FIG. 53A, disassembled to allow viewing of exemplary components, including, e.g., but not limited to, an exemplary plurality of light emitting diodes (LED) affixed upon exemplary LED board, exemplary first end including an interior end having an exemplary pair of holes each adapted for receiving a screw from an exterior end (not shown) of the first end of the tube light, as well as various wires and a first coupler for coupling to a mating coupler on the LED board, the first end shown with advantageous silicone placed in an opaque cavity to isolate electronic components, where the exemplary LED board is shown slidably inserted into an exemplary slot of the exemplary sideboard, according to an exemplary embodiment;

FIG. 53E depicts an exemplary embodiment of the exemplary tube light of FIG. 53A, disassembled to allow viewing of exemplary components, including, e.g., but not limited to, an exemplary plurality of light emitting diodes (LED) affixed upon exemplary LED board, exemplary first end including an exterior end illustrating an exemplary pair of electrical couplers, and having an exemplary pair of openings through which a pair of screws may be placed through holes shown in FIGS. 53D and 53H, as well as, the mating coupler on the exemplary LED board, shown slidably inserted into an exemplary slot of the exemplary sideboard 5304, according to an exemplary embodiment;

FIG. 53F depicts an exemplary embodiment of an exemplary end view of the exemplary sideboard of the exemplary tube light of FIG. 53A, disassembled to allow viewing of exemplary components, according to an exemplary embodiment;

FIG. 53G depicts an exemplary embodiment of an exemplary edge view of the exemplary sideboard of the exemplary tube light of FIG. 53A, disassembled to allow viewing of exemplary components, according to an exemplary embodiment;

FIG. 53H depicts an exemplary embodiment of the exemplary tube light of FIG. 53A, disassembled to allow viewing of exemplary components, including, e.g., but not limited to, an exemplary tube having exemplary rail(s) into which may be slidably placed the exemplary side board, which in turn may include exemplary LED board slidably placed therein, exemplary first end 5302a is shown decoupled from the mating coupler (not labeled) of the LED board according to an exemplary embodiment;

FIG. 53I depicts an exemplary second end and associated coupler configured to be releasably coupled to exemplary mating coupler, and/or illustrating the end piece coupled to the exemplary LED plate, according to an exemplary embodiment;

FIG. 53J depicts an exemplary embodiment of another exemplary tube LED bulb, according to an exemplary embodiment, which may include, e.g., but not limited to, an LED board placed below a center of the tube, enabling using reflective and embedded side board(s) to reflect light, and may enable using less LED packages than without the reflective side board; an exemplary plastic tube; exemplary embedded wire(s) in, e.g., the side board(s), and/or in the LED board, etc.; an exemplary optional projection to put wires in; an exemplary side board(s) with angles to reflect light; an exemplary printed circuit board (PCB) or LED board, and/or may include, e.g., a single LED board, and/or may be split into 2 or more part(s) and inserted into both sides of the tube, according to exemplary embodiments;

FIG. 53K depicts an exemplary LED tube, along with exemplary rail(s) on exemplary interior wall(s) of the tube, according to an exemplary embodiment;

FIG. 53L depicts an exemplary long LED tube, with exemplary features which may include 48 inch long, 1650 lumens, 16.5 watt, 4100K color temperature, exemplary T8 socket, 36.5 year life at 3 hours per day, fluorescent tube replacement bulb, according to an exemplary embodiment;

FIG. 53M depicts an exemplary short LED tube, with exemplary features which may include 24 inch long, 825 lumens, 8.25 watt, 4100K color temperature, T8 socket, 36.5 year life at 3 hours per day, fluorescent tube replacement bulb, according to an exemplary embodiment;

FIG. 53N depicts an exemplary cross-section of an exemplary embodiment of an alternative LED tube, along with exemplary rail(s) on exemplary interior wall(s) of the tube, according to an exemplary embodiment;

FIG. 53O depicts an exemplary cross-section of an exemplary embodiment of another alternative LED tube 5306, along with exemplary rail(s) on exemplary interior wall(s) of the tube, according to an exemplary embodiment;

FIG. 53P depicts an exemplary cross-section of an exemplary embodiment of yet another alternative LED tube 5306, along with exemplary rail(s) on exemplary interior wall(s) of the tube, according to an exemplary embodiment;

FIG. 54A-54D depict various exemplary internal reflectors according to an exemplary embodiment;

FIG. 55A depicts an exemplary exploded view of an exemplary bent star LED plate unidirectional LED light bulb;

FIG. 55B depicts an exemplary internal reflector according to an exemplary embodiment;

FIG. 55C depicts an exemplary triangular prism LED post according to an exemplary embodiment;

FIG. 55D depicts an exemplary square pyramidal post LED source, according to an exemplary embodiment;

FIG. 55E depicts an exemplary flood light bulb with an exemplary removably or nonremovably, attachable external reflector, according to an exemplary embodiment;

FIG. 55F depicts an exemplary angled bent cross LED plate according to an exemplary embodiment;

FIG. 55G depicts an exemplary light bulb with an exemplary removably or nonremovably, attachable external reflector, according to an exemplary embodiment;

FIG. 55H depicts an exemplary light bulb with an exemplary internal reflector/disperser/diffuser, according to an exemplary embodiment;

FIG. 55I depicts an exemplary image illustrating an exemplary holding plate, which is part of the heat sink, where the heat sink is downward, where the tope 50% accounts for 70% weight of the heatsink, the LED module or PCB board is slightly below the holding plate but no space is provided between the PCB and the holding plate, according to an exemplary embodiment;

FIG. 56 depicts an exemplary remote control including an exemplary display and/or touchscreen and/or user interface, according to an exemplary embodiment, which may be coupled via an exemplary wireless communications network to control one or more of the exemplary LED bulbs according to an exemplary embodiment;

FIG. 57 depicts an exemplary remote control including an exemplary display and/or touchscreen and/or user interface and/or optional buttons and/or optional keys, according to an exemplary embodiment, which may be coupled via an exemplary wireless communications network to control one or more of the exemplary LED bulbs according to an exemplary embodiment;

FIG. 58A depicts an exemplary globe LED light bulb, which may include exemplary brightness of 850 lumens (or other exemplary 800 (820 lumen), or exemplary 600 (610 lumen), etc., 9 watts energy usage, exemplary 3000K color temperature, exemplary standard E26 socket size, a lifetime of 36.5 years at 3 hours of usage per day, 85 watt incandescent replacement, may be used as a directional spot light bulb without reflector attached, or may be used as an omnidirectional and/or all purpose, light bulb with exemplary reflector attached, according to one exemplary embodiment;

FIG. 58B depicts an exemplary exploded view of an exemplary embodiment of the exemplary globe LED bulb, according to an exemplary embodiment;

FIG. 58C depict an exemplary orthographic top view of an exemplary exterior diffuser/reflector, with exemplary nonlimiting dimensions, according to an exemplary embodiment;

FIG. 58D depict an exemplary orthographic front view of exemplary exterior diffuser/reflector, with exemplary nonlimiting dimensions, according to an exemplary embodiment;

FIG. 58E depict an exemplary orthographic side view of an exemplary exterior diffuser/reflector, with exemplary nonlimiting dimensions, according to an exemplary embodiment; and

FIG. 59 depicts an exemplary computer system as may be used in an exemplary gateway and/or other wireless component such as a wireless transceiver, according to an exemplary embodiment.

### DETAILED DESCRIPTION OF THE INVENTION

### Exemplary Embodiments

FIG. 1 is an exemplary view 100 of an exemplary isometric perspective view of an exemplary candle light bulb, with exemplary standard light socket, according to an exemplary embodiment of the present invention.

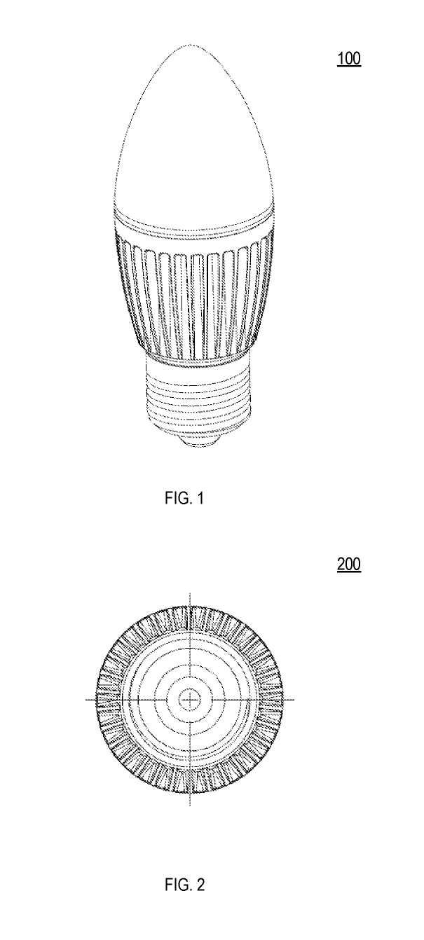

FIG. 2 is an exemplary bottom orthographic view 200 of the exemplary candle light bulb according to an exemplary embodiment of the present invention.

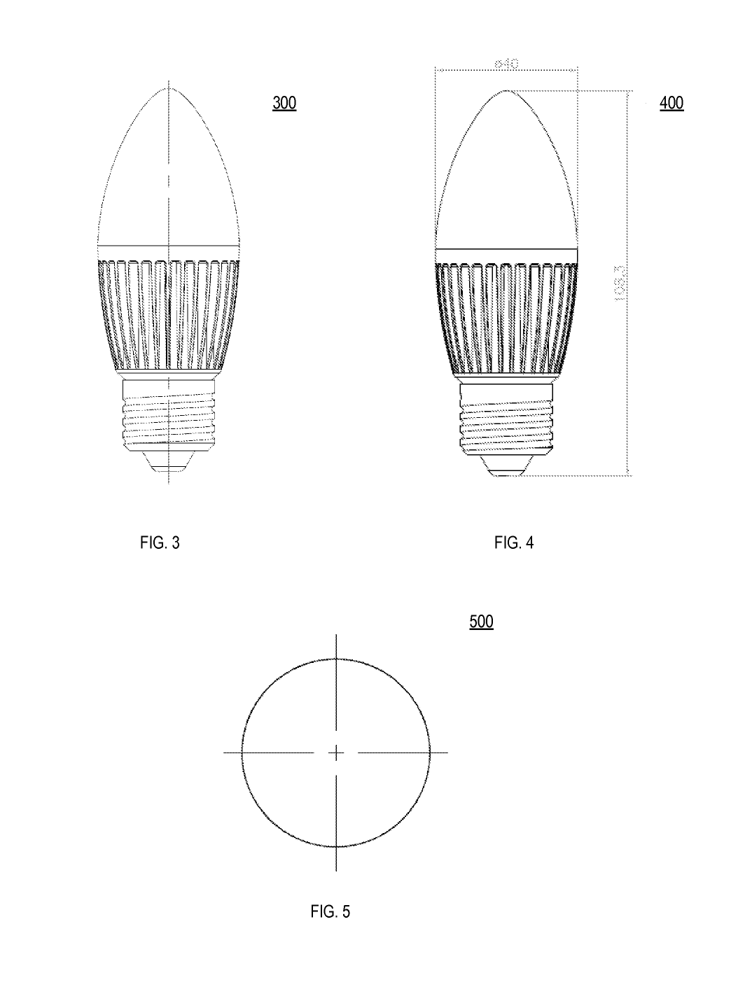

FIG. 3 is an exemplary side orthographic view 300 of the exemplary candle light bulb according to an exemplary embodiment of the present invention.

FIG. 4 is an exemplary side orthographic view 400 of the exemplary candle light bulb with exemplary nonlimiting dimensions according to an exemplary embodiment of the present invention.

FIG. 5 is an exemplary orthographic top view of the exemplary candle light bulb according to an exemplary embodiment of the present invention.

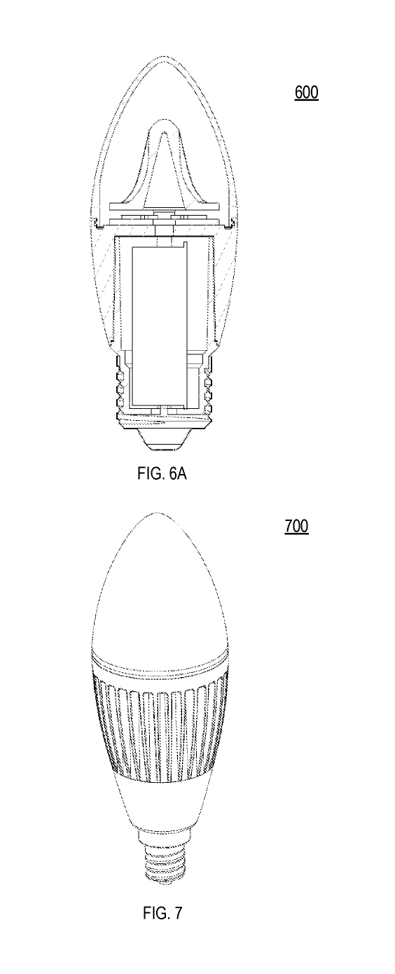

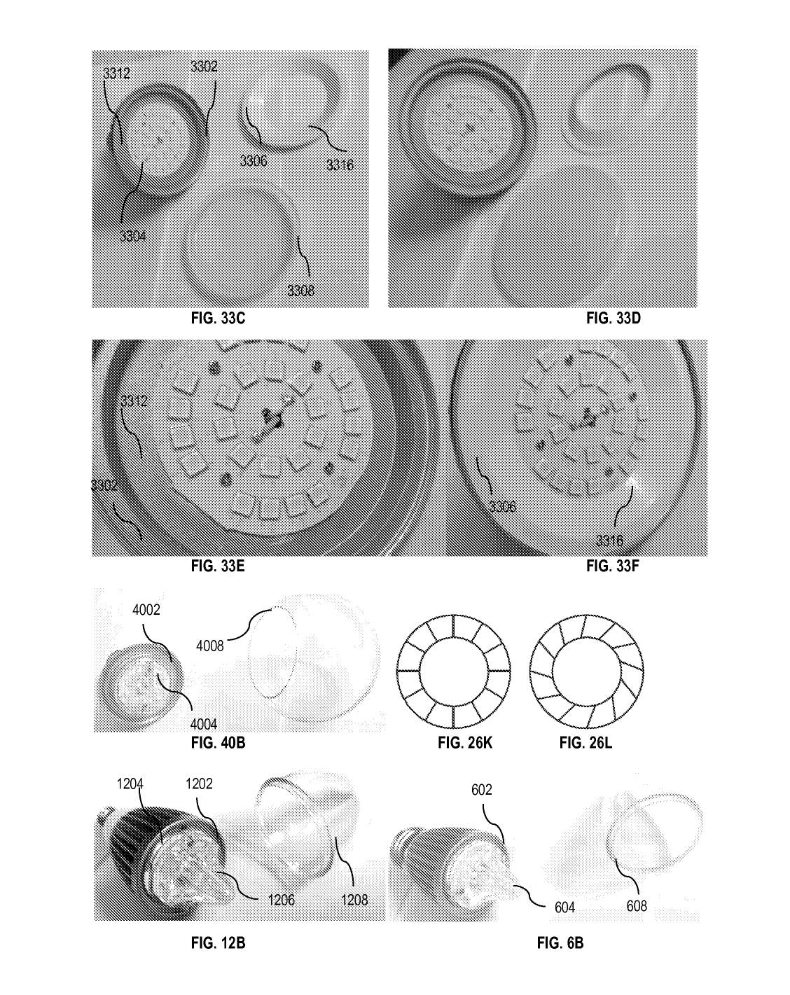

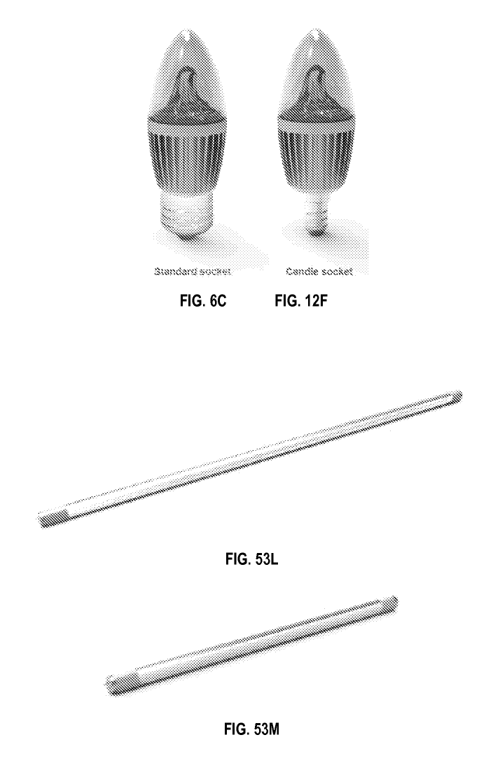

FIG. 6A is an exemplary partial cutaway cross-sectional view 600 of the exemplary candle light bulb with standard socket size, illustrating an exemplary cavity for holding an exemplary electronic printed circuit board (PCB) and exemplary drive circuitry for driving LEDs of the LED plate, according to the exemplary embodiment of the present invention.

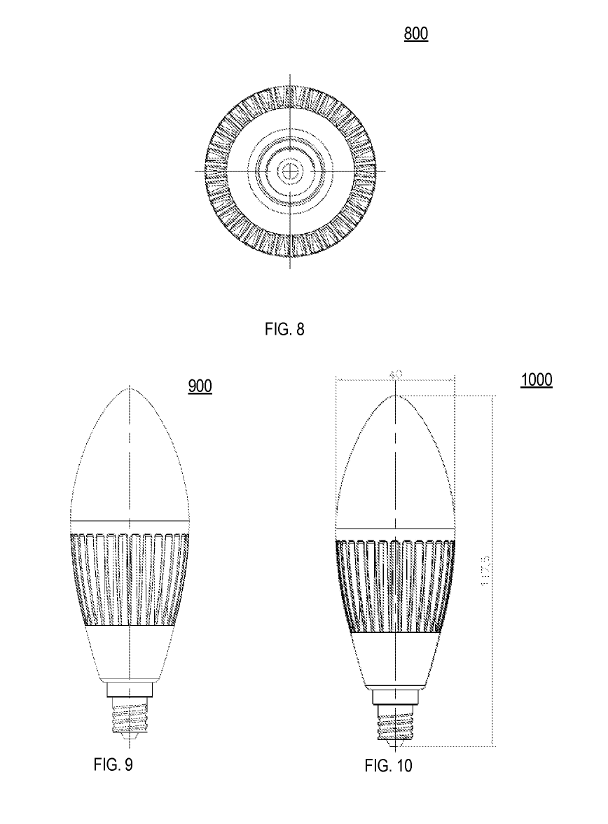

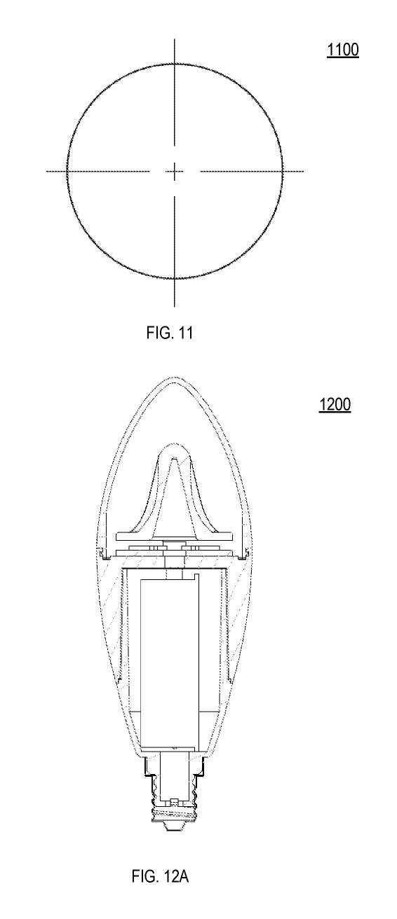

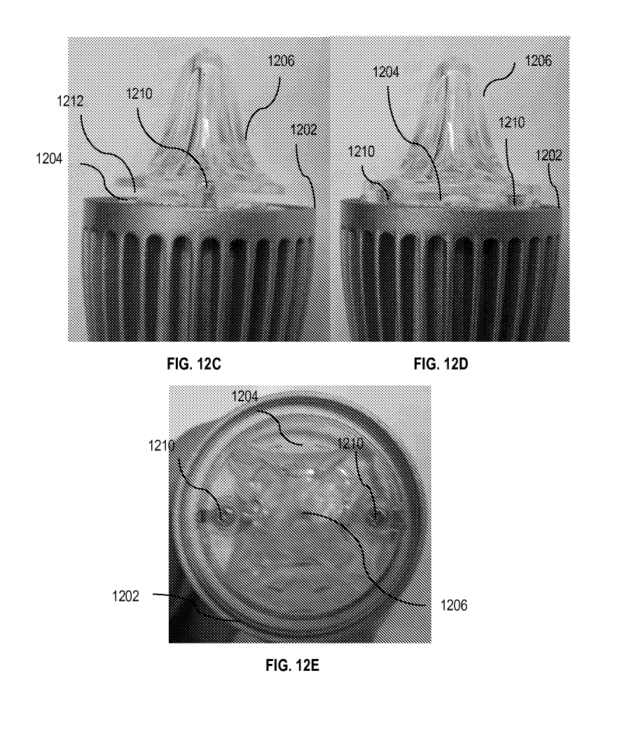

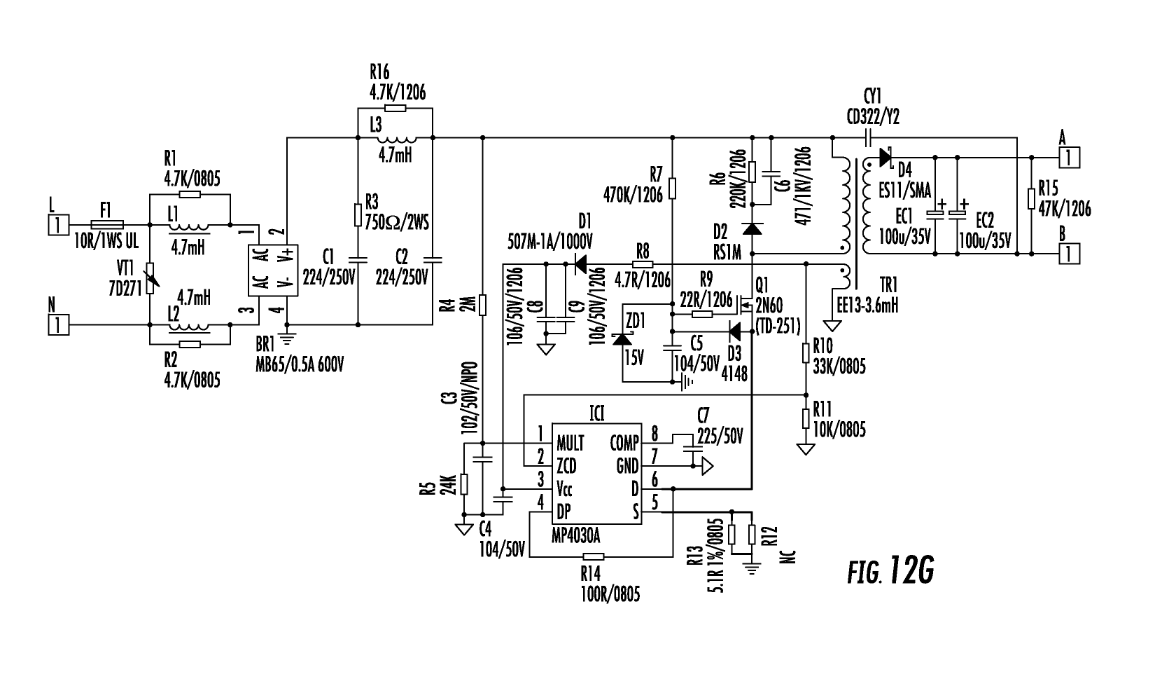

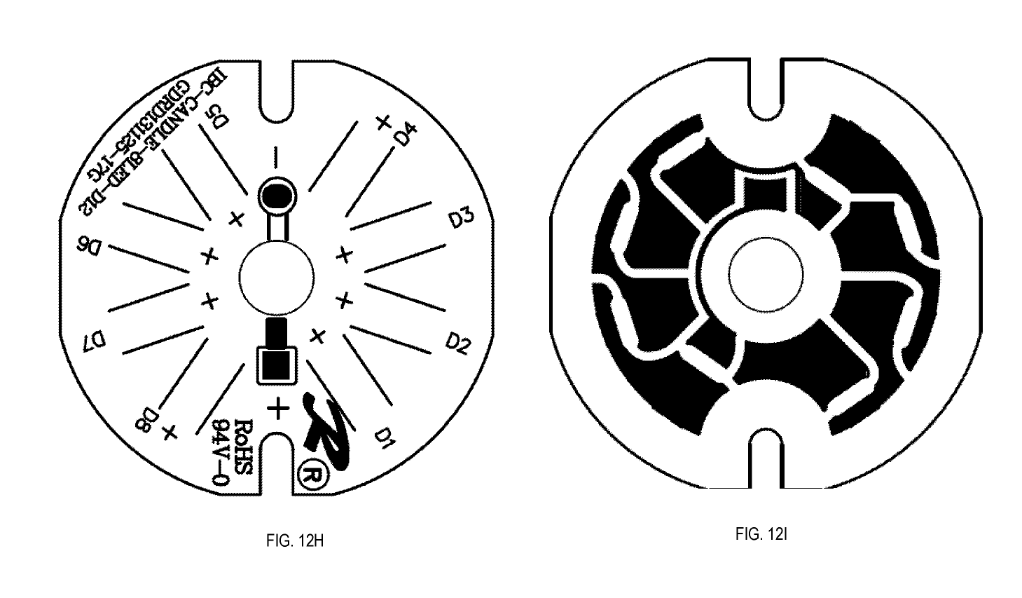

FIG. 6B depicts an exemplary embodiment of a candle with exemplary glass or plastic cover removed illustrating an exemplary diffuser, similar to the exemplary diffuser described further with reference to FIG. 12 below, according to an exemplary embodiment.

FIG. 6C depicts an exemplary standard socket candle bulb, of exemplary 350 lumen brightness, 3.5 watt energy usage, 3000K color temperature, E12 Candle socket size, 36.5 year lifetime based on 3 hours of usage per day, 35-40 watt incandescent bulb replacement, according to an exemplary embodiment.

FIG. 7 is an exemplary isometric perspective view 700 of an exemplary narrow socket candle light bulb according to an exemplary embodiment of the present invention.

FIG. 8 is an exemplary bottom orthographic view 800 of the exemplary narrow candle socket candle LED light bulb according to an exemplary embodiment of the present invention.

FIG. 9 is an exemplary side orthographic view 900 of the exemplary narrow candle socket candle LED light bulb according to an exemplary embodiment of the present invention.

FIG. 10 is an exemplary side orthographic view 1000 of the narrow candle socket candle LED light bulb with exemplary nonlimiting dimensions according to an exemplary embodiment of the present invention.

FIG. 11 is an exemplary top orthographic view 1100 of the exemplary narrow candle socket candle LED light bulb according to an exemplary embodiment of the present invention.

FIG. 12A is an exemplary partial cutaway cross-section view 1200 of the exemplary narrow socket candle light bulb according to an exemplary embodiment of the present invention.

FIG. 12B depicts an exemplary embodiment of a candle with exemplary glass or plastic cover removed illustrating an exemplary diffuser, according to an exemplary embodiment.

FIG. 12C depicts an exemplary side view of an exemplary embodiment of a candle with exemplary glass or plastic cover removed, illustrating an exemplary diffuser in side view illustrating one of a pair of screw couplings, according to an exemplary embodiment.

FIG. 12D depicts another exemplary side view of the exemplary embodiment of a candle with exemplary glass or plastic cover removed, illustrating a front side view orthogonal to the side view of FIG. 12C, of the exemplary diffuser with a pacifier shaped side view, illustrating the pair of screws coupling the exemplary diffuser to the exemplary LED planar plate, with an exemplary spacing between the diffuser and LED planar, according to an exemplary embodiment.

FIG. 12E depicts an exemplary top view of the exemplary embodiment of a candle with exemplary glass or plastic cover removed, illustrating a top view orthogonal to the side view of FIGS. 12C and 12D, of the exemplary diffuser, having an exemplary pyramid with concave sides shape, having an x-top view, illustrating the pair of screws coupling the exemplary diffuser to the exemplary LED planar plate, surrounded by an exemplary holding plate according to an exemplary embodiment.

FIG. 12F depicts an exemplary candle socket candle bulb, of exemplary 350 lumen brightness, 3.5 watt energy usage, 3000K color temperature, E12 candle socket size, 36.5 year lifetime based on 3 hours of usage per day, 35-40 watt incandescent bulb replacement, according to an exemplary embodiment.

FIG. 12G depicts an isolated power driver circuit for an exemplary candle LED bulb, according to an exemplary embodiment.

FIG. 12H depicts an exemplary top view of the LED printed circuit board for an exemplary 8 LED candle LED planar plate, according to an exemplary embodiment.

FIG. 12I depicts an exemplary bottom view of the LED printed circuit board for an exemplary 8 LED candle LED planar plate, according to an exemplary embodiment.

FIG. 12J depicts an isolated power driver circuit for an exemplary candle LED bulb with an E26 socket, according to an exemplary embodiment.

An exemplary candle light may include an exemplary E26 socket and/or an E13 socket. In other exemplary embodiments, other candle bulbs, and other bulbs too, may include a GU 10 and/or a GU5.3 socket, or other twist and lock sockets, as will be apparent to those skilled in the art, according to an exemplary embodiment. Certain embodiments, according to an exemplary embodiment, may be MR-16 replacement lamps.

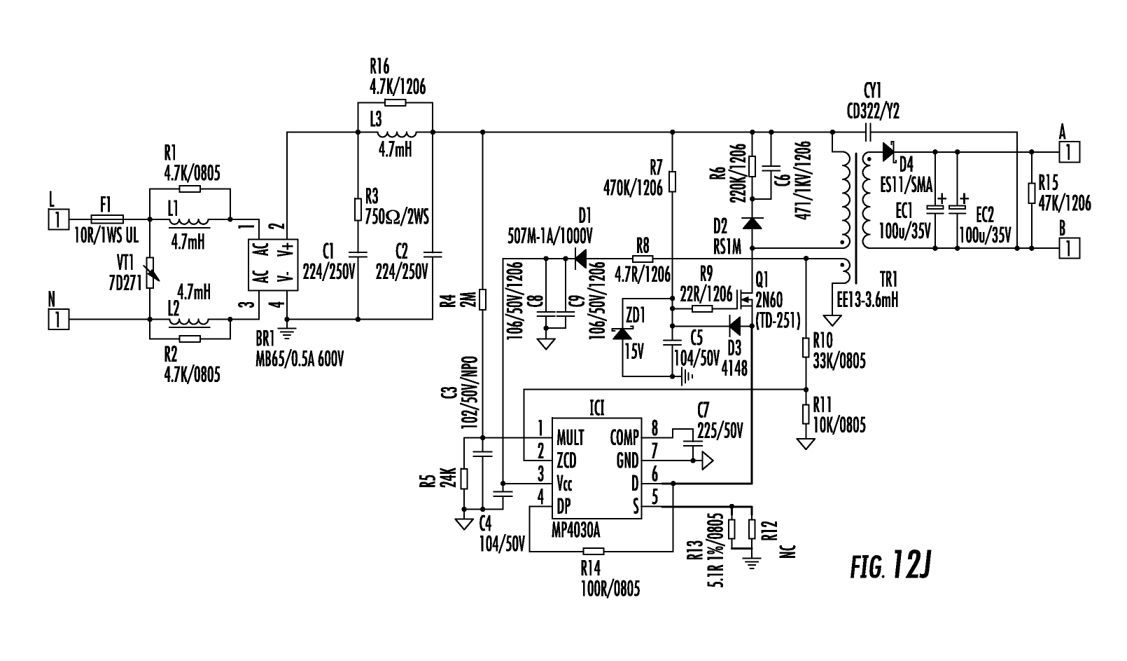

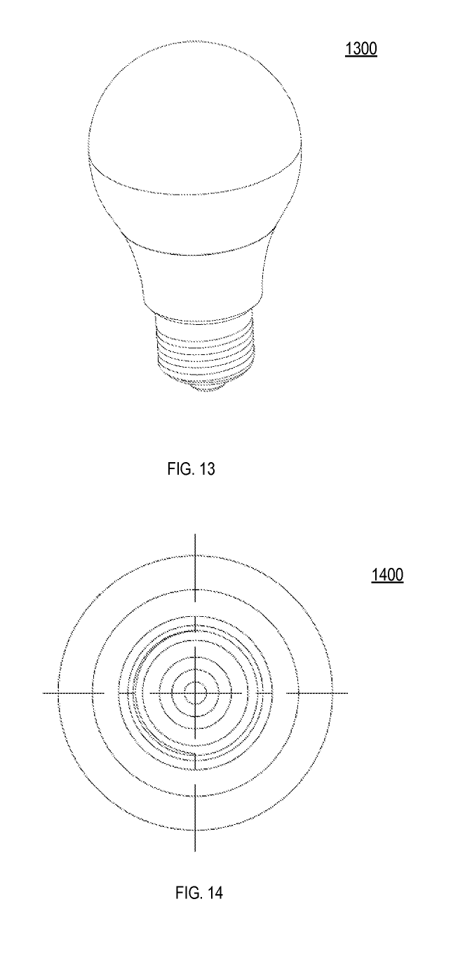

FIG. 13 is an exemplary isometric perspective view 1300 of an exemplary desk light bulb according to an exemplary embodiment of the present invention.

FIG. 14 is an exemplary bottom orthographic view 1400 of the exemplary desk light bulb according to an exemplary embodiment of the present invention.

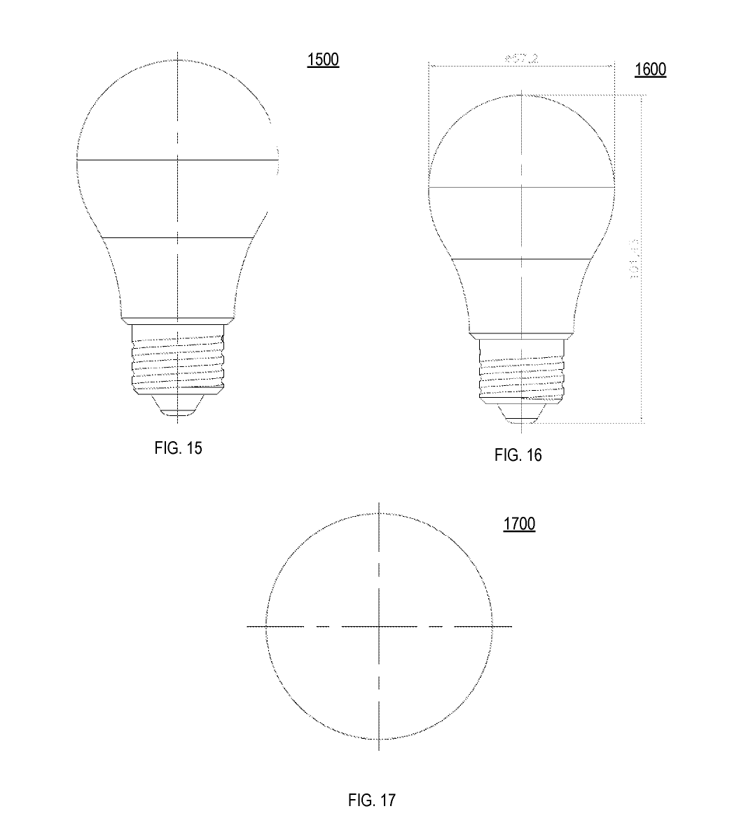

FIG. 15 is an exemplary side orthographic view 1500 of the exemplary desk light bulb according to an exemplary embodiment of the present invention.

FIG. 16 is an exemplary side orthographic view 1600 of the exemplary desk light bulb with exemplary nonlimiting dimensions according to an exemplary embodiment of the present invention.

FIG. 17 is an exemplary top orthographic view 1700 of the exemplary desk light bulb according to an exemplary embodiment of the present invention.

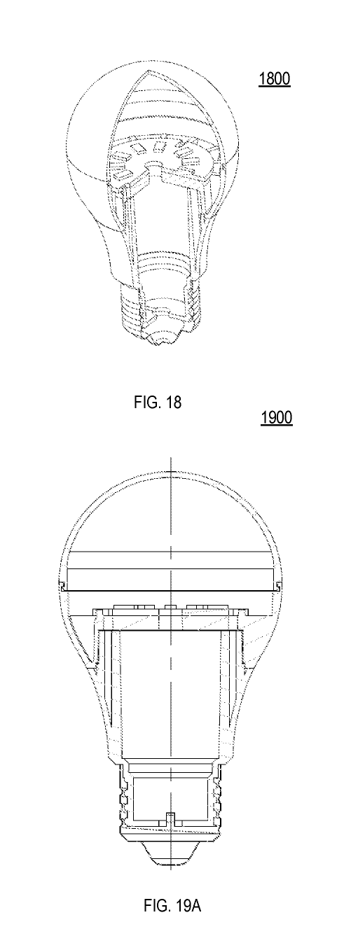

FIG. 18 is an exemplary isometric partial cutaway section view 1800 of the exemplary desk light bulb according to an exemplary embodiment of the present invention.

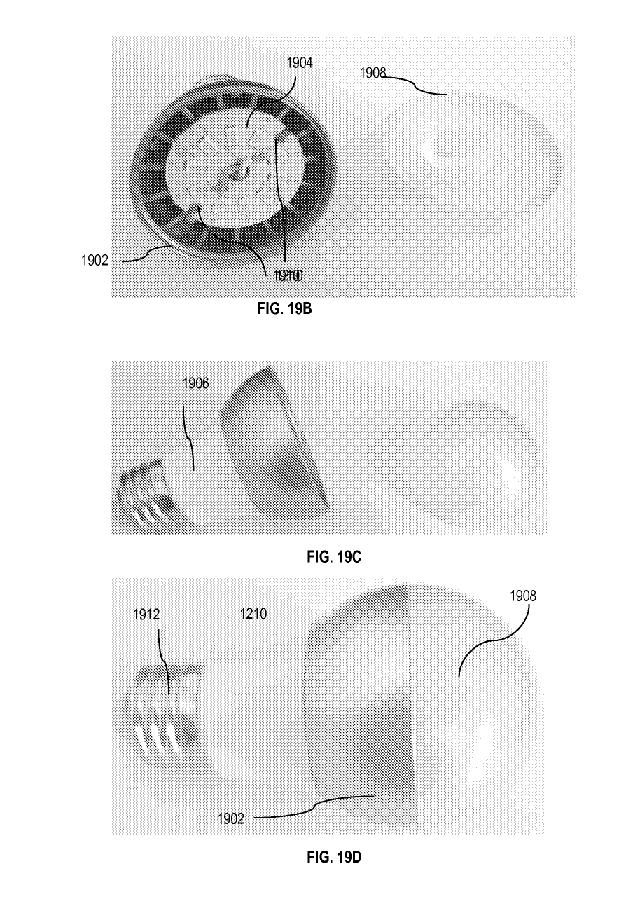

FIG. 19A is an exemplary partial cross-section view 1900 of the exemplary desk globe light bulb, which may in an exemplary embodiment include 400 Lumens brightness, 4 watts of energy usage, a color temperature of 3000K, a standard E26 socket size, a lifetime of 36.5 years based on 3 hours of usage each day, replacement for a 40 watt incandescent bulb, according to an exemplary embodiment of the present invention.

FIG. 19B depicts an exemplary top view of an exemplary embodiment of the exemplary desk light with cover 1908 removed illustrating an exemplary LED plate 1904 coupled by screws 1910 to an exemplary Aluminum holding plate 1902, according to an exemplary embodiment.

FIG. 19C depicts an exemplary side view of an exemplary embodiment of the exemplary desk light with cover removed illustrating an exemplary aluminum holding plate and an exemplary plastic exterior portion 1906, according to an exemplary embodiment.

FIG. 19D depicts an exemplary embodiment of the exemplary desk light with standard screw electric contact 1912, an exemplary cover 1908, attached illustrating an exemplary substantially spherically shaped portion comprising the exemplary aluminum holding plate 1902 and exemplary glass or plastic cover 1908, which may be coated with an exemplary silicone coating, according to an exemplary embodiment.

Another exemplary desk light may come with either a clear lens, and/or a frosted polycarbonate, as shown, according to an exemplary embodiment.

FIG. 19E depicts an exemplary isolated power driver, which advantageously reduces or eliminates a risk of a shock hazard, according to an exemplary embodiment of the present invention.

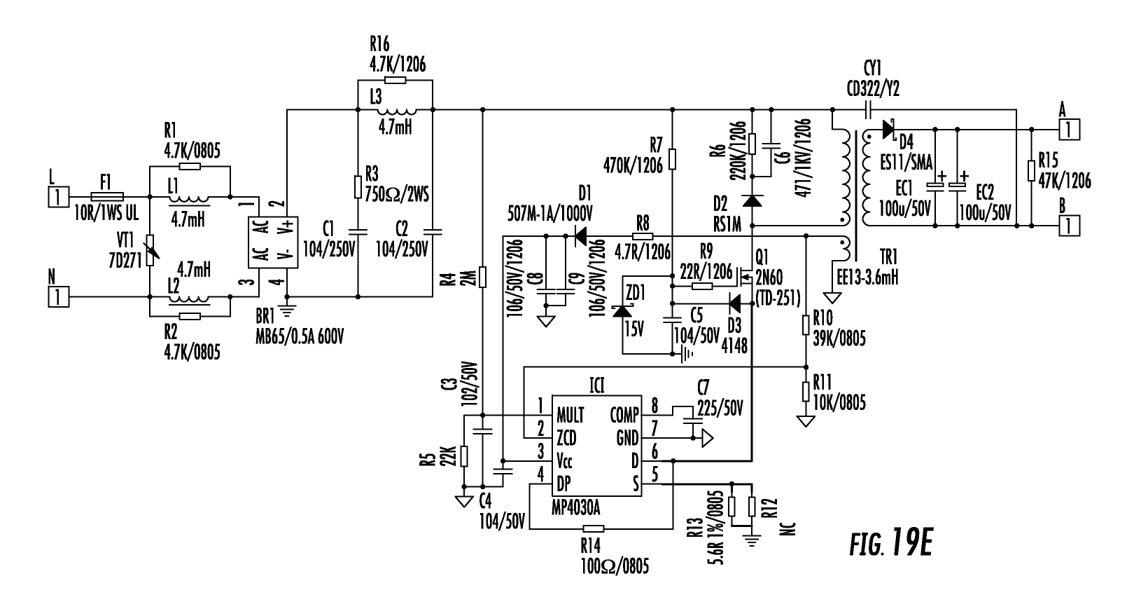

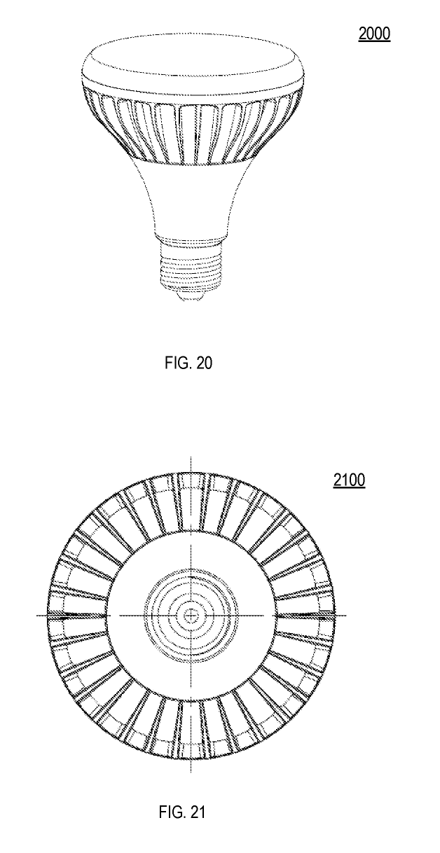

FIG. 20 is an exemplary isometric perspective view 2000 of an exemplary flood light bulb to an exemplary embodiment of the present invention.

FIG. 21 is an exemplary bottom orthographic view 2100 of the exemplary flood light bulb according to an exemplary embodiment of the present invention.

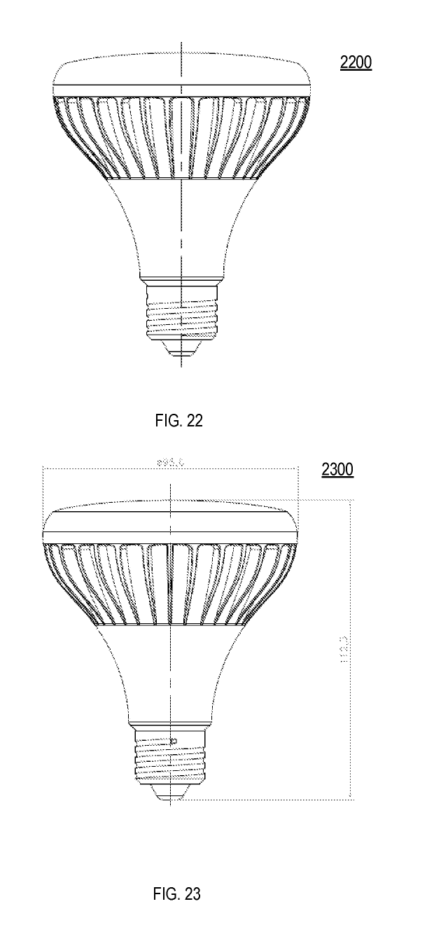

FIG. 22 is an exemplary side orthographic view 2200 of the exemplary flood light bulb according to an exemplary embodiment of the present invention.

FIG. 23 is an exemplary side view 2300 of the exemplary flood light bulb with exemplary nonlimiting dimensions according to an exemplary embodiment of the present invention.

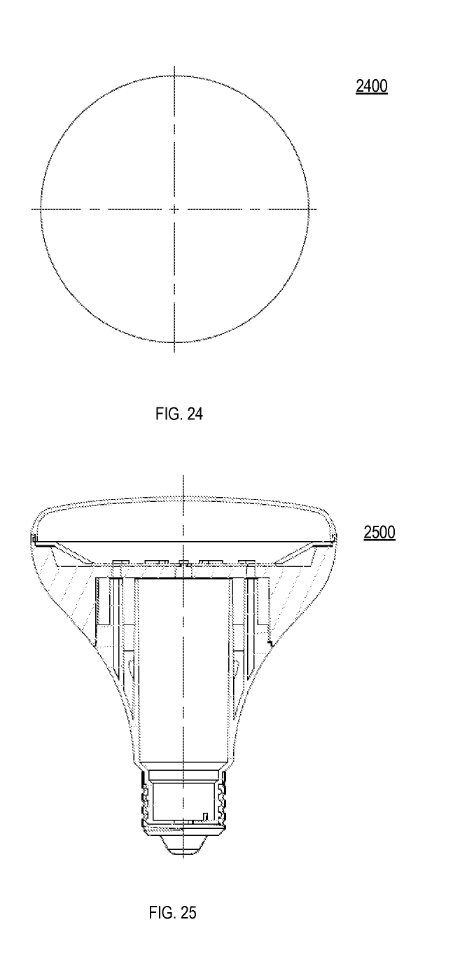

FIG. 24 is an exemplary top orthographic view 2400 of the exemplary flood light bulb 2400 according to an exemplary embodiment of the present invention.

FIG. 25 is an exemplary partial cross-section view 2500 of the exemplary flood light bulb according to an exemplary embodiment of the present invention.

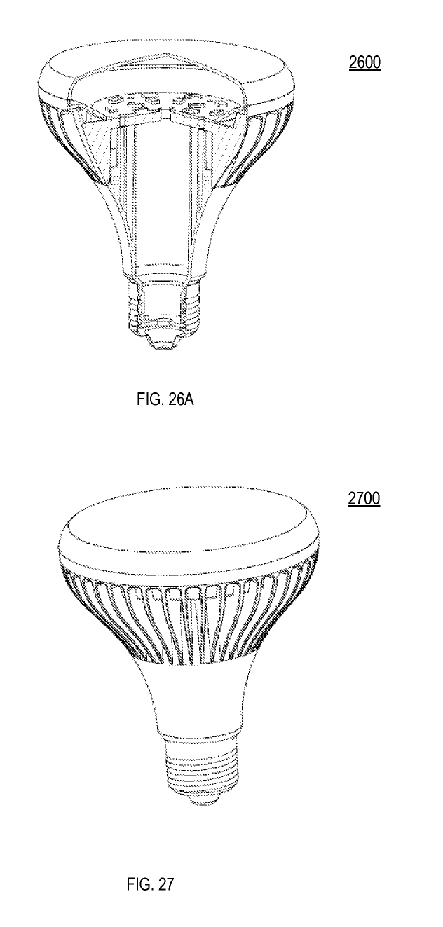

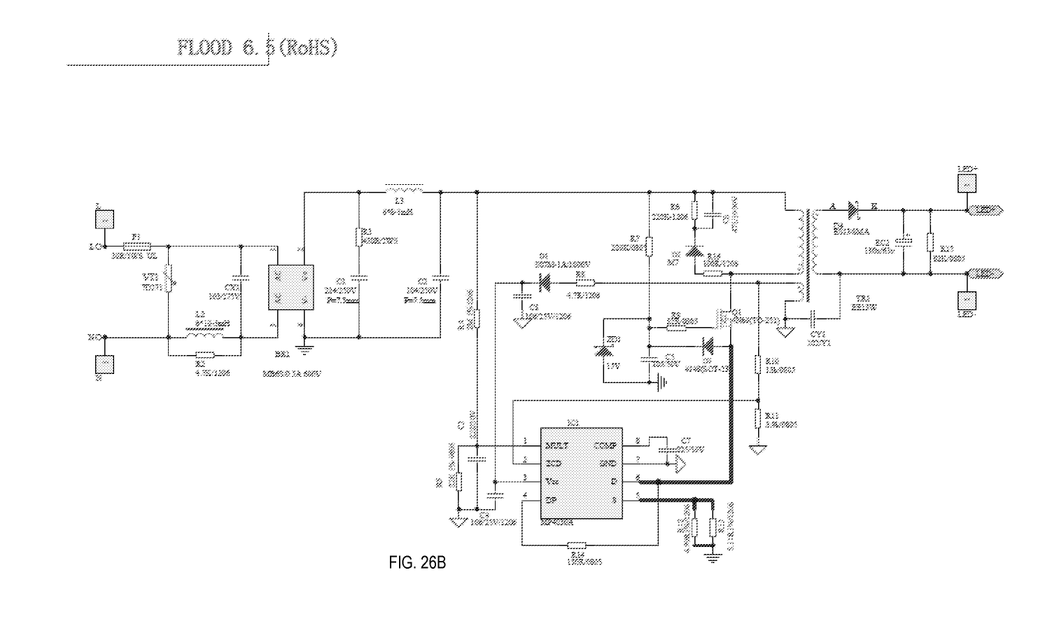

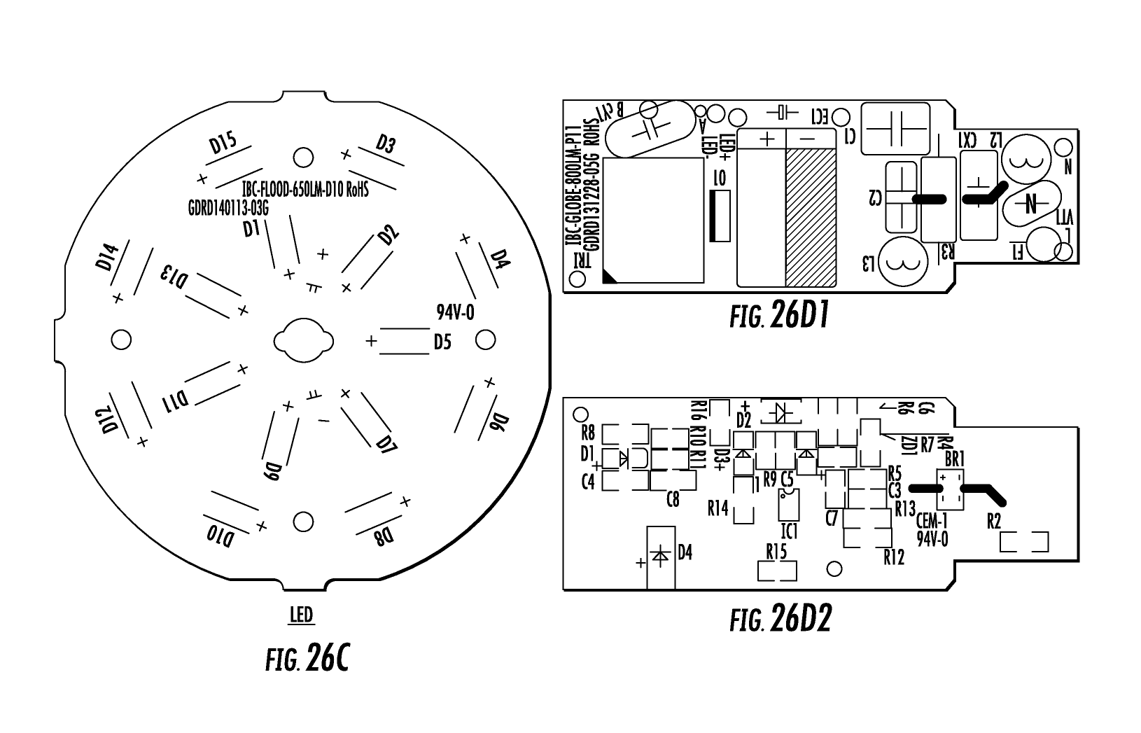

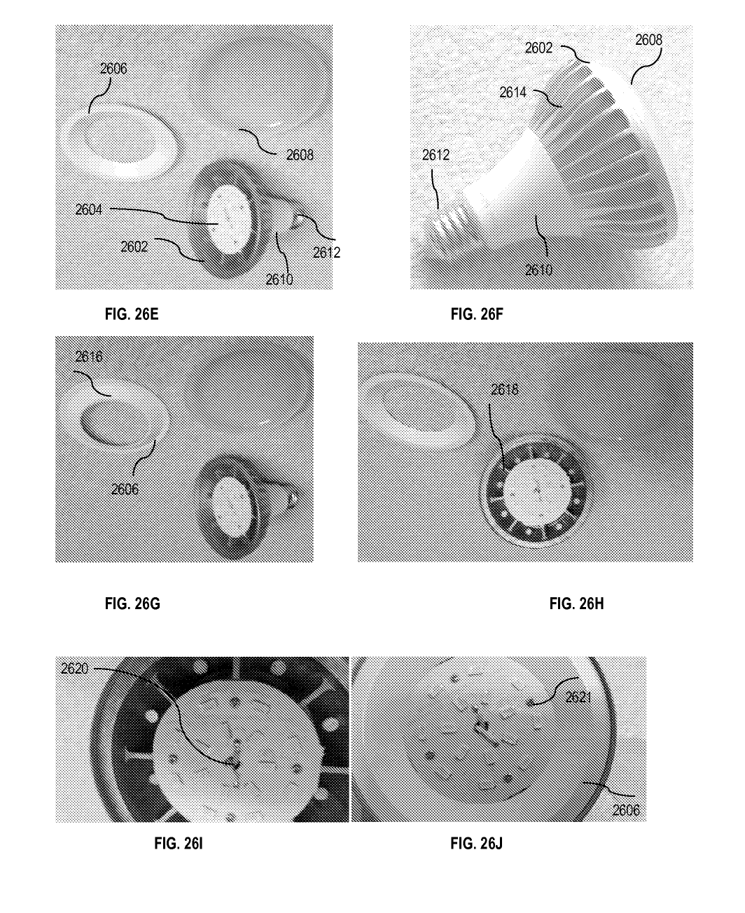

FIG. 26A is an exemplary partial cutaway isometric section view 2600 of the exemplary flood light bulb, illustrating the solid holding plate of one exemplary embodiment, according to an exemplary embodiment of the present invention.

FIG. 26B depicts an isolated power driver, according to an exemplary embodiment of the present invention.

FIG. 26C depicts an exemplary top view of an exemplary flood light LED planar plate, according to an exemplary embodiment.

FIG. 26D1 depicts an exemplary top view of an exemplary printed circuit board for an exemplary globe LED light, according to an exemplary embodiment.

FIG. 26D2 depicts an exemplary top view of an exemplary printed circuit board for an exemplary globe LED light, according to an exemplary embodiment.

FIG. 26E depicts an exemplary embodiment of an exemplary disassembled flood light bulb comprising an exemplary aluminum holding plate 2602, an exemplary plastic exterior conical bell shaped body 2610, exemplary socket 2612, LED planar plate 2604, exemplary plastic annular conical funnel 2606 from a top view, and exemplary plastic or glass cover 2608 according to an exemplary embodiment of the present invention.

FIG. 26F depicts an exemplary embodiment of an exemplary assembled flood light bulb comprising an exemplary aluminum holding plate 2602, an exemplary plastic exterior conical bell shaped body 2610, exemplary socket 2612, exemplary heat dissipation fin(s) 2614, and exemplary plastic or glass cover 2608 according to an exemplary embodiment of the present invention.

FIG. 26G depicts an exemplary embodiment of an exemplary disassembled flood light bulb of FIG. 26E comprising an exemplary aluminum holding plate 2602, an exemplary plastic exterior conical bell shaped body 2610, exemplary socket 2612, exemplary heat dissipation fin(s) 2614, exemplary plastic annular conical funnel 2606 from a bottom view, and exemplary plastic or glass cover 2608 according to an exemplary embodiment of the present invention.

FIG. 26H depicts an exemplary embodiment of an exemplary disassembled flood light bulb of FIG. 26E comprising an exemplary aluminum holding plate 2602 from a top view, including one or more internal rib(s) 2618, forming spaces about the LED plate 2604, in one embodiment, an exemplary plastic exterior conical bell shaped body 2610, exemplary socket 2612, exemplary plastic annular conical funnel 2606 from a bottom view, and exemplary plastic or glass cover 2608 according to an exemplary embodiment of the present invention.

FIG. 26I depicts an exemplary top view of an exemplary embodiment of an exemplary disassembled flood light bulb of FIG. 26E comprising power supply wires 2620 for providing power from the socket up to the LED plate 2604, according to an exemplary embodiment of the present invention.

FIG. 26J depicts an exemplary top view of an exemplary embodiment of an exemplary disassembled flood light bulb of FIG. 26E comprising screws 2621 holding the LED planar plate 2604 to the holding plate 2602, and with exemplary plastic annular conical funnel plastic reflector 2606 surrounding LED plate 2604, according to an exemplary embodiment of the present invention.

FIGS. 26K and 26L depict alternative embodiments of alternative holding plate inner structures as may be used in alternative embodiments of various bulbs, according to other exemplary embodiments of the present invention.

FIG. 27 is an exemplary isometric perspective view 2700 of another exemplary flood light bulb according to an exemplary embodiment of the present invention.

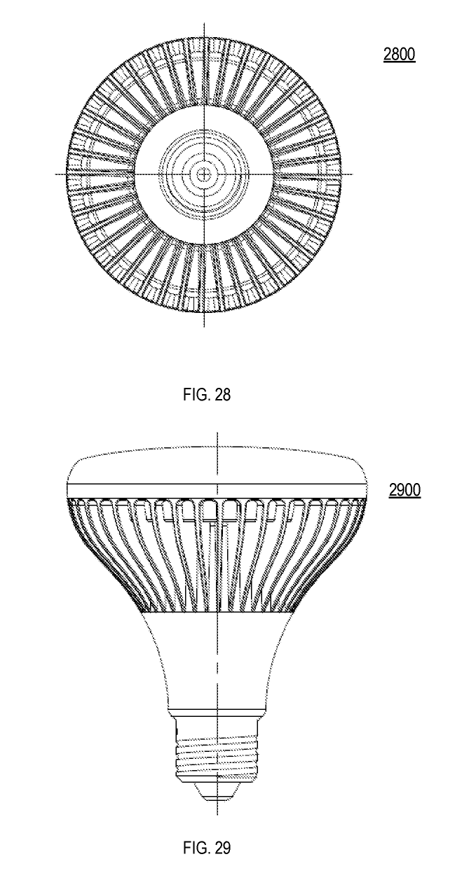

FIG. 28 is an exemplary bottom orthographic view of the other exemplary flood light bulb according to an exemplary embodiment of the present invention.

FIG. 29 is an exemplary side orthographic view 2900 of the other exemplary flood light bulb according to an exemplary embodiment of the present invention.

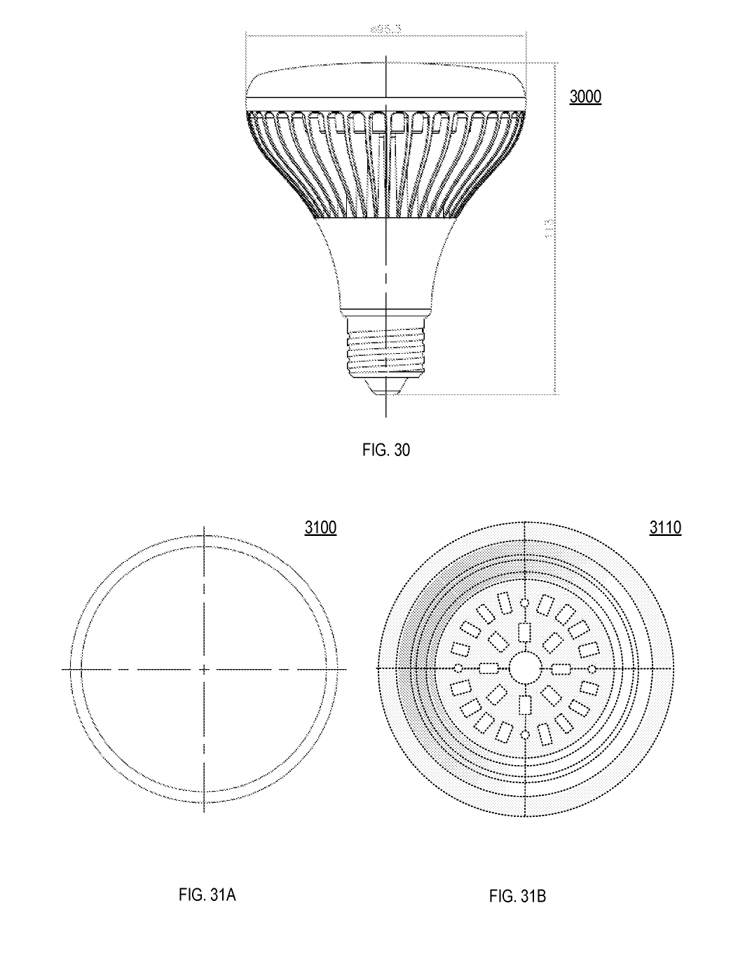

FIG. 30 is an exemplary side orthographic view 3000 of the other exemplary flood light bulb with exemplary nonlimiting dimensions according to an exemplary embodiment of the present invention.

FIG. 31A is an exemplary top orthographic view 3100 of the other exemplary flood light bulb according to an exemplary embodiment of the present invention.

FIG. 31B is a top view 3110 of an exemplary LED package layout for an exemplary flood light bulb according to an exemplary embodiment.

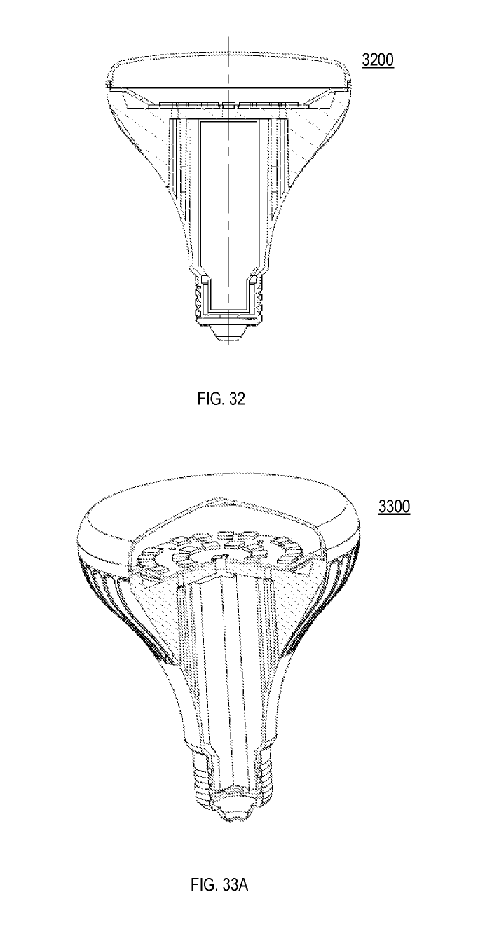

FIG. 32 is an exemplary partial cross-section view 3200 of the other exemplary flood light bulb according to an exemplary embodiment of the present invention.

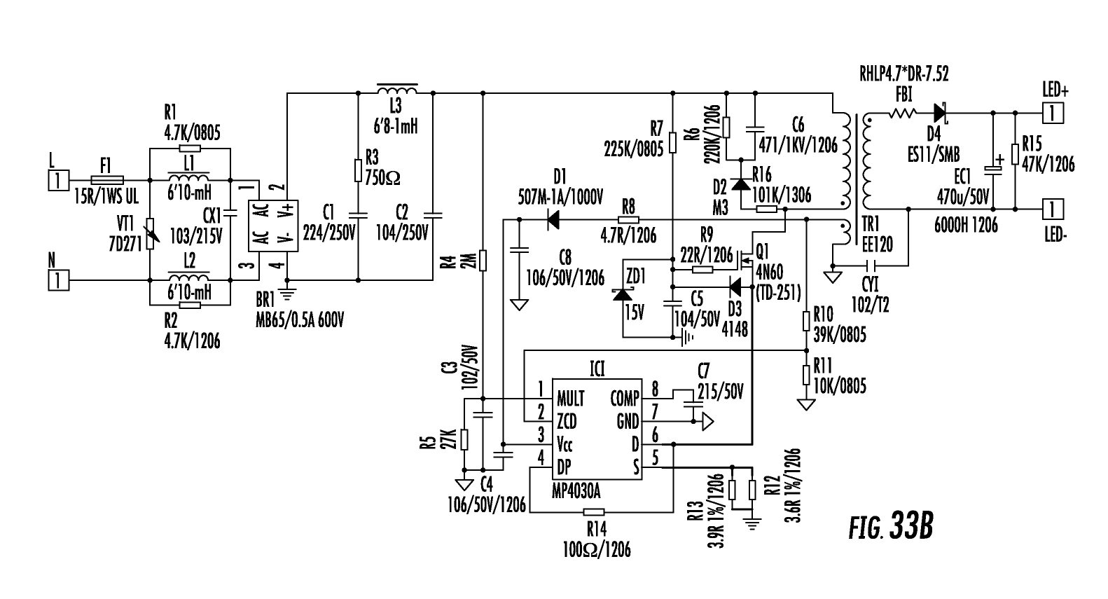

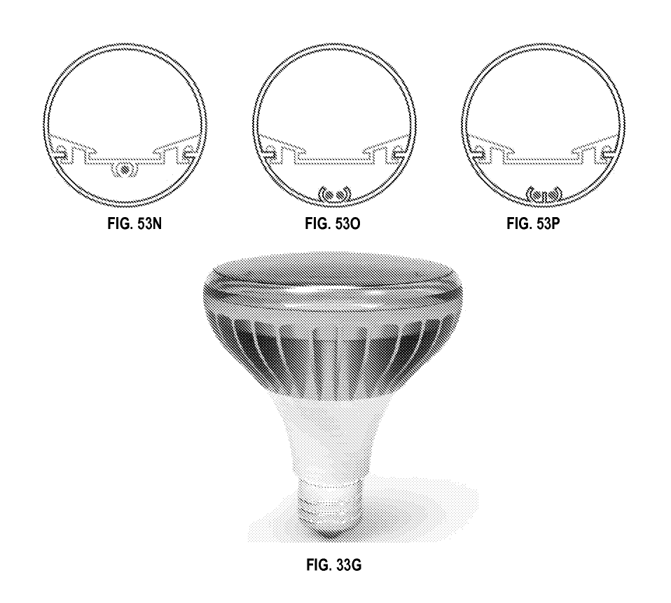

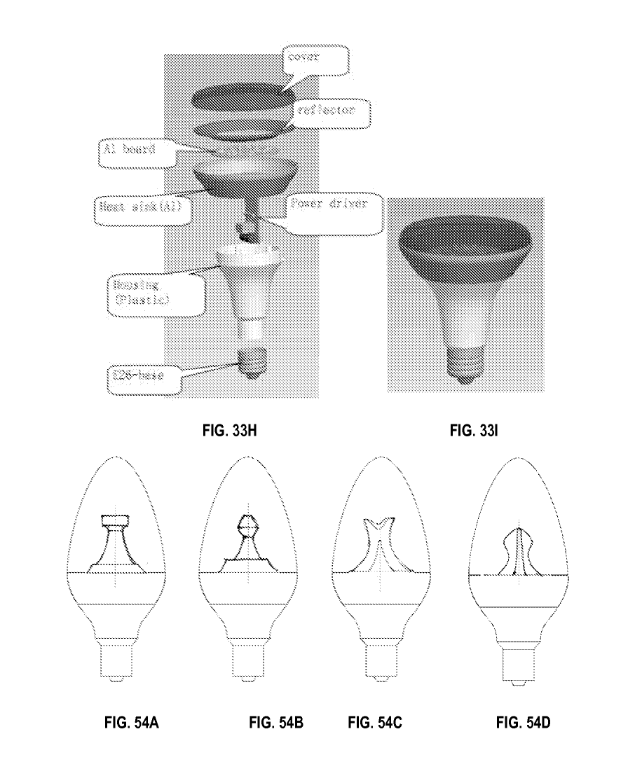

FIG. 33A is an exemplary isometric partial cutaway section view 3300 of the exemplary other flood light bulb according to an exemplary embodiment of the present invention.

FIG. 33B depicts an exemplary schematic diagram of an exemplary isolated power driver circuit, according to an exemplary embodiment.

FIG. 33C depicts an exemplary embodiment of an exemplary disassembled flood light bulb comprising an exemplary aluminum holding plate 3302, an exemplary plastic exterior conical bell shaped body 3310 (not shown in this view), exemplary socket 3312 (not shown in this view), exemplary LED planar plate 3304, exemplary plastic annular conical funnel 3306/3316 from a top view, and exemplary plastic or glass cover 3308 according to an exemplary embodiment of the present invention.

FIG. 33D depicts an exemplary embodiment of an exemplary disassembled flood light bulb of FIG. 26E comprising an exemplary aluminum holding plate 3302, exemplary plastic annular 3306 and conical 3316 funnel from a bottom view, and exemplary plastic or glass cover 3308 according to an exemplary embodiment of the present invention.

FIG. 33E depicts exemplary Aluminum holding plate 3302 including solid portion 3312, which advantageously leaves no gap or spacing between the LED plate and the holding plate 3302, according to one exemplary embodiment.

FIG. 33F depicts the LED flood light bulb with the exemplary plastic annular conical funel placed atop the holding plate 3302, according to an exemplary embodiment.

FIG. 33G depicts an exemplary flood light bulb in assembled view with exemplary brightness of 1050 lumens, with exemplary energy usage of 11 watts, a color temperature of 3000K, an E26 standard socket size, a 36.5 year lifetime with 3 hours of usage per day, and a 100 watt incandescent bulb replacement, according to an exemplary embodiment.

Another exemplary embodiment of a flood light may include a 400 lumen or about 420 lumen exemplary flood light.

FIG. 33H depicts an exploded view of an exemplary embodiment of the flood light bulb including exemplary cover, internal reflector, Aluminum LED plate board, Aluminum heat sink holding plate, power driver, plastic housing, and standard E26 socket base, according to an exemplary embodiment.

FIG. 33I depicts the exemplary embodiment of FIG. 33H assembled, according to an exemplary embodiment.

FIG. 33J depicts an exemplary bottom view of an exemplary LED plate as may be used in an exemplary flood light of an exemplary embodiment of the present invention.

FIG. 33K depicts an exemplary top view of an exemplary LED plate as may be used in an exemplary flood light of an exemplary embodiment of the present invention.

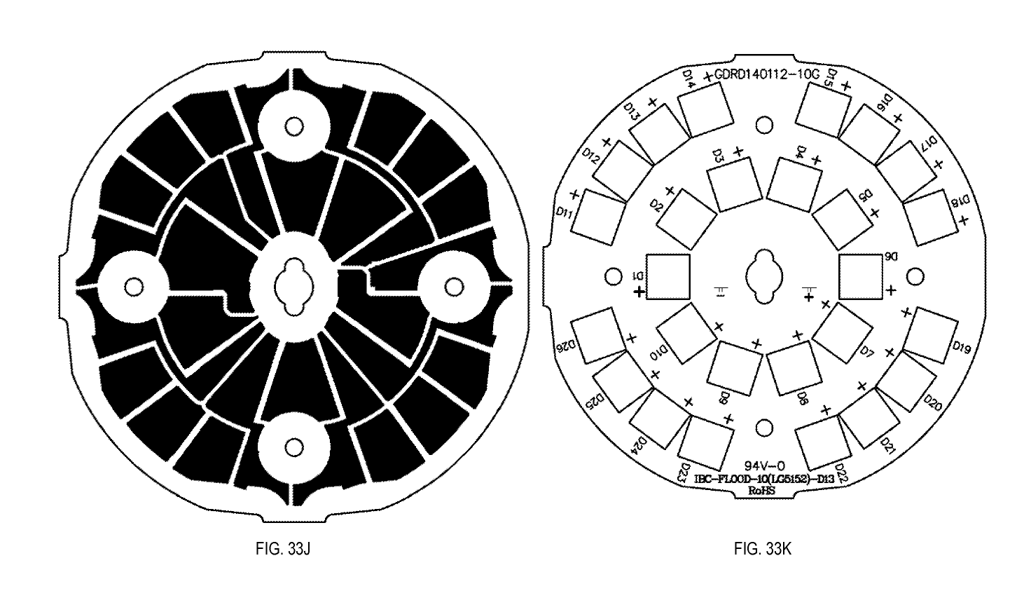

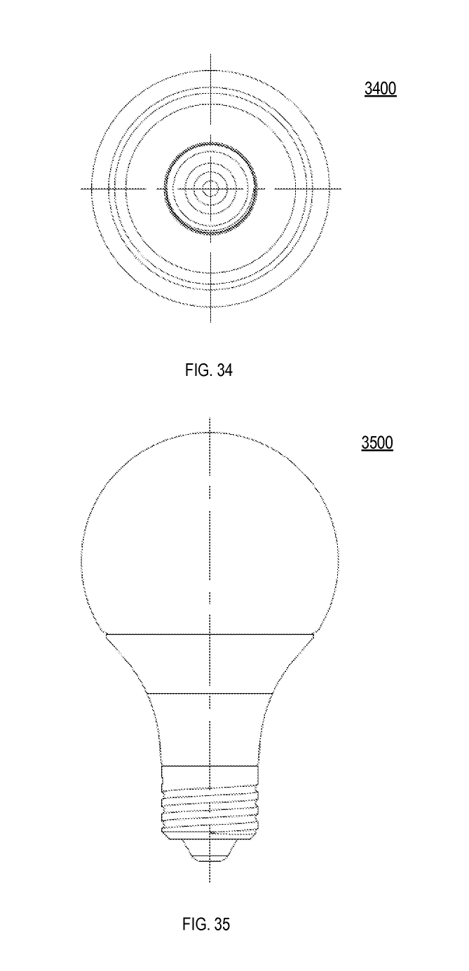

FIG. 34 is an exemplary bottom orthographic view 3400 of an exemplary vanity light bulb of FIG. 35 according to an exemplary embodiment of the present invention.

An exemplary vanity lighting apparatus may include an exemplary clear lens version, and/or an exemplary frosted polycarbonate version, according to an exemplary embodiment.

FIG. 35 is an exemplary side orthographic view 3500 of an exemplary vanity light bulb according to an exemplary embodiment of the present invention.

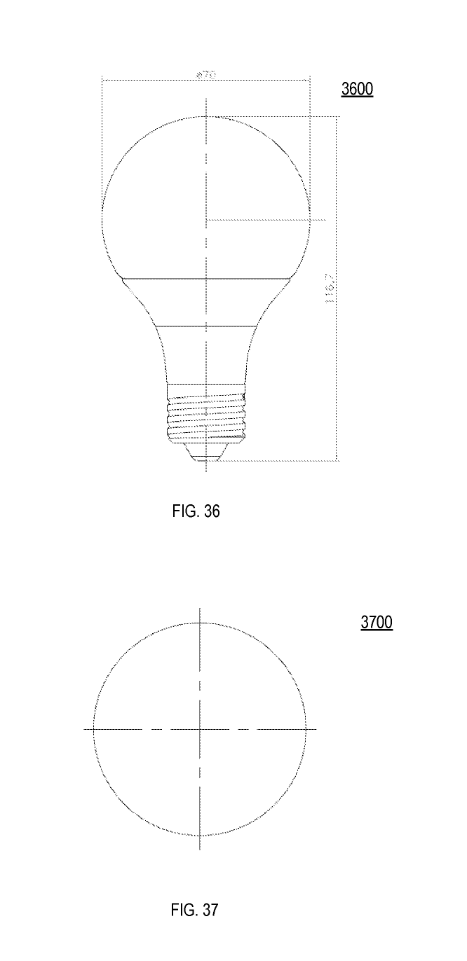

FIG. 36 is an exemplary side orthographic view of the exemplary vanity light bulb with exemplary nonlimiting dimensions according to an exemplary embodiment of the present invention.

FIG. 37 is an exemplary top orthographic view 3700 of the exemplary vanity light bulb according to an exemplary embodiment of the present invention.

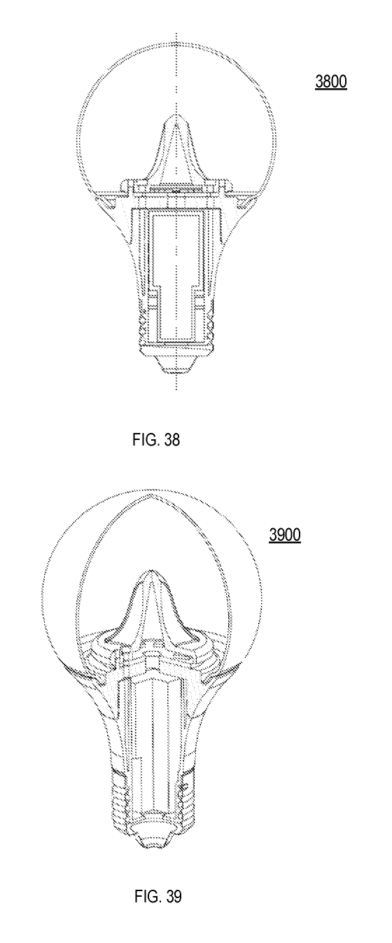

FIG. 38 is an exemplary partial cutaway cross-section view 3899 of the exemplary vanity light bulb according to an exemplary embodiment of the present invention.

FIG. 39 is an exemplary isometric partial cutaway cross-section view 3900 of the exemplary vanity light bulb according to an exemplary embodiment of the present invention.

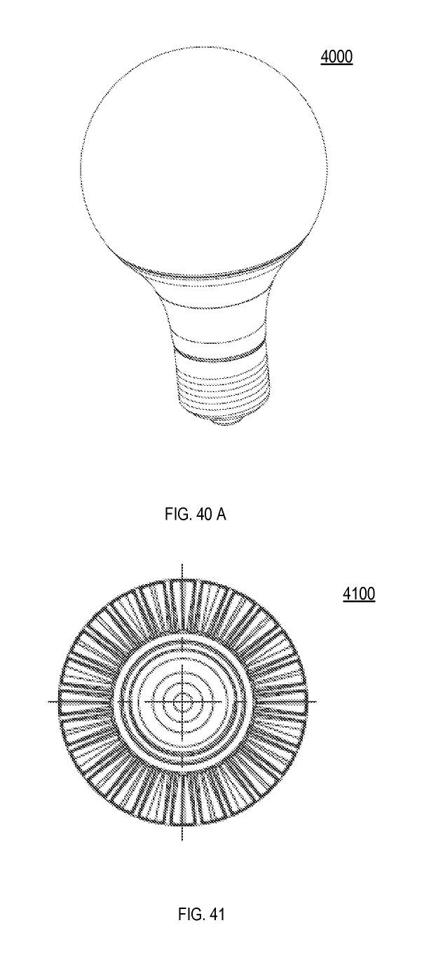

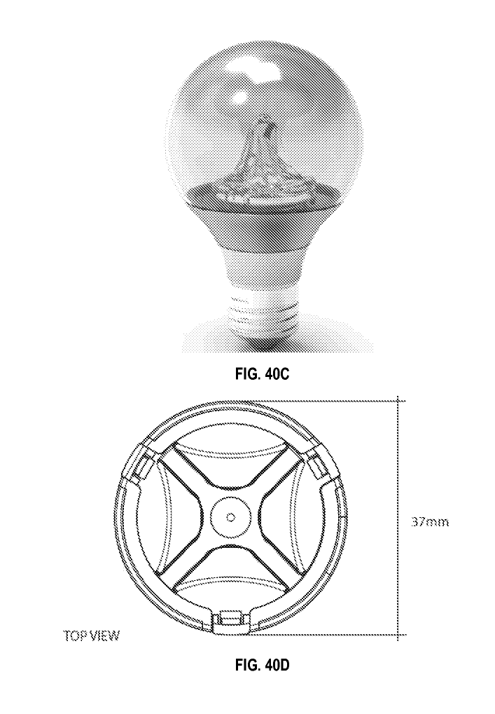

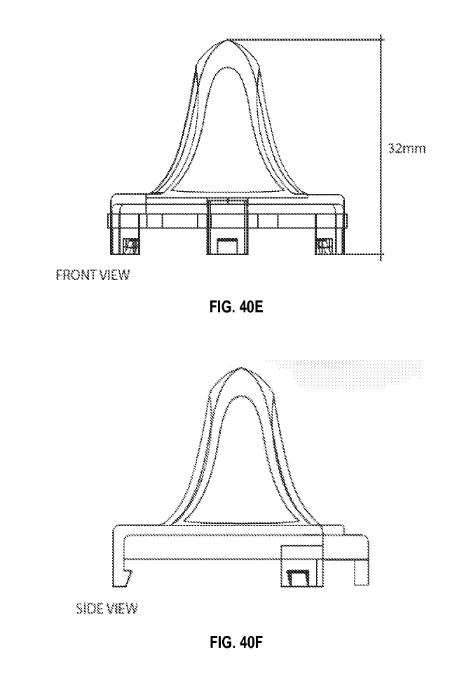

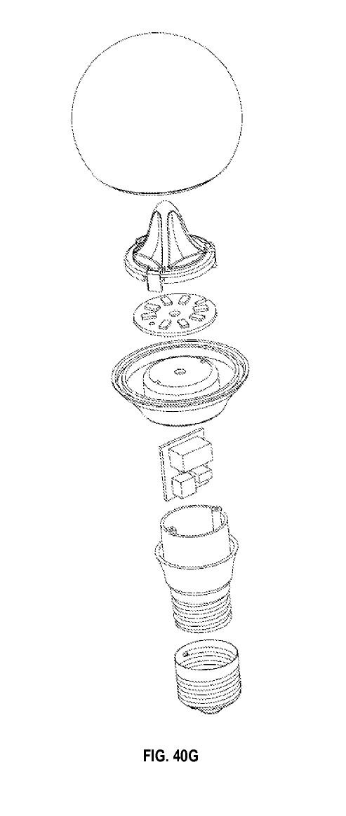

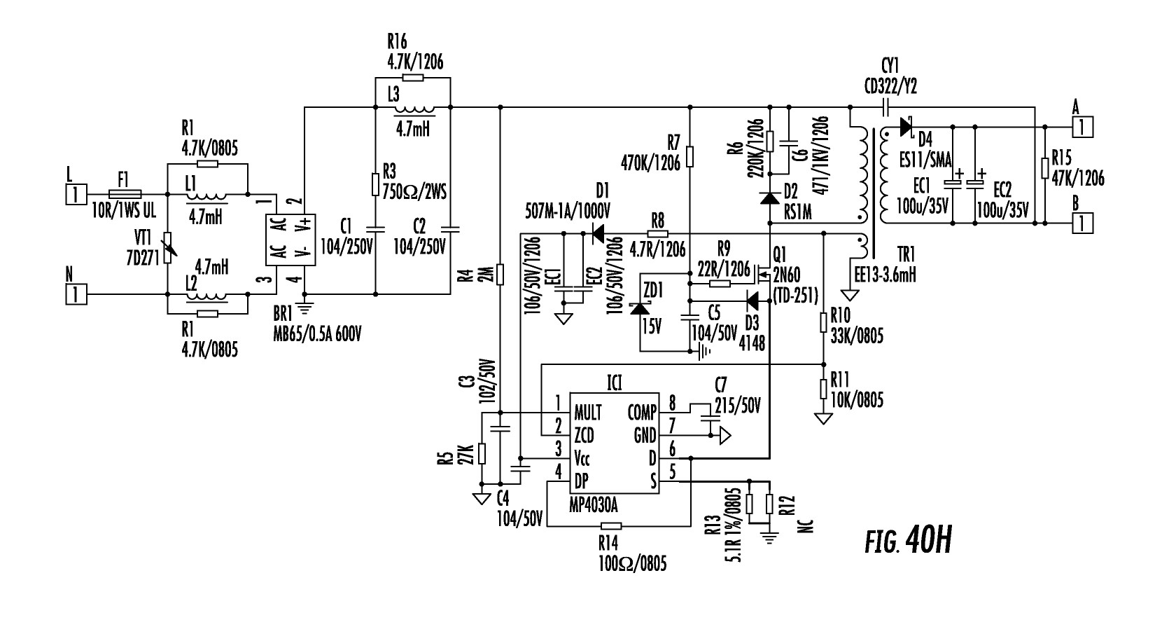

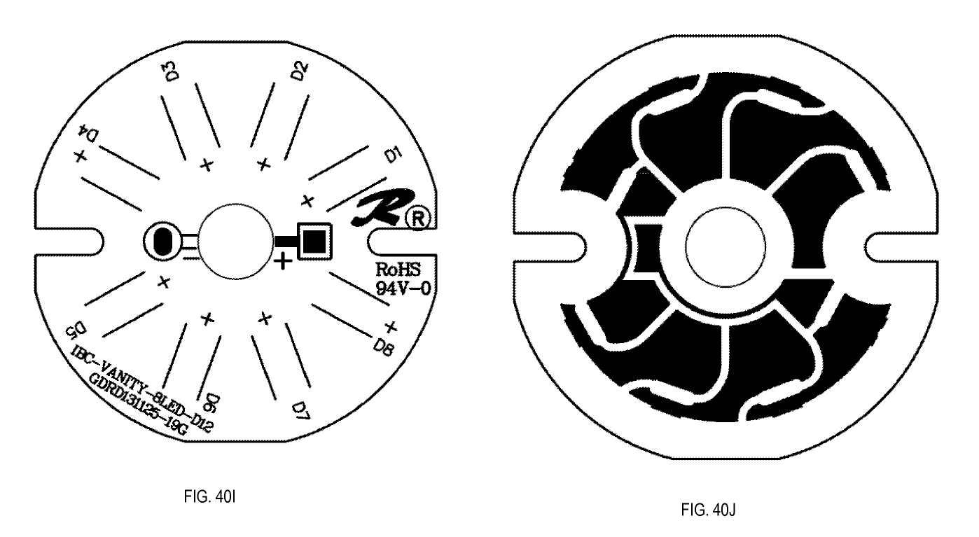

FIG. 40A is an exemplary isometric perspective view 4000 of the exemplary vanity light bulb according to an exemplary embodiment of the present invention.

FIG. 40B depicts an exemplary view of the exemplary embodiment of the exemplary vanity light bulb with exemplary glass or plastic cover removed, illustrating a circular LED plate, an exemplary diffuser, illustrating the pair of screws coupling the exemplary diffuser to the exemplary LED planar plate, according to an exemplary embodiment.

FIG. 40C depicts an exemplary assembled view of the exemplary vanity light bulb of exemplary brightness 350 lumens, 4 watts energy usage, color temperature of 3000K, standard socket size E26, a 36.5 year lifetime based on 3 hours per day usage, 40 watt lightbulb replacement, according to an exemplary embodiment.

FIG. 40D depict an exemplary orthographic top view of an exemplary diffuser, with exemplary dimensions, according to an exemplary embodiment.

FIG. 40E depict an exemplary orthographic front view of an exemplary diffuser, with exemplary dimensions, according to an exemplary embodiment.

FIG. 40F depict an exemplary orthographic side view of an exemplary diffuser, with exemplary dimensions, according to an exemplary embodiment.

FIG. 40G depict an exemplary exploded view of an exemplary LED bulb, with exemplary dimensions, according to an exemplary embodiment.

FIG. 40H depicts an exemplary isolated power driver according to an exemplary embodiment.

FIG. 40I depicts an exemplary bottom view of an exemplary embodiment of an exemplary LED plate for an exemplary vanity bulb, according to an exemplary embodiment.

FIG. 40J depicts an exemplary top view of an exemplary embodiment of an exemplary LED plate for an exemplary vanity bulb, according to an exemplary embodiment.

FIG. 41 is an exemplary bottom orthographic view 4100 of the exemplary other flood light bulb shown in FIG. 30, according to an exemplary embodiment of the present invention.

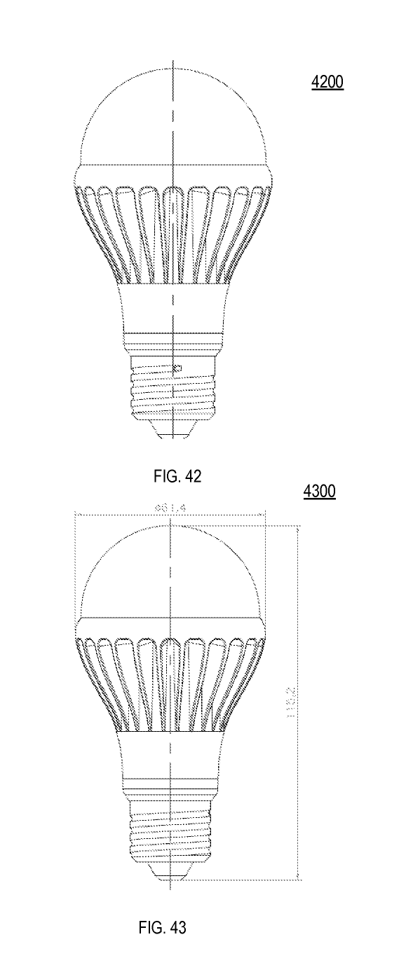

FIG. 42 is a side orthographic view 4200 of a globe light bulb according to an exemplary embodiment of the present invention.

FIG. 43 is a side orthographic view 4300 of the globe light bulb with exemplary nonlimiting dimensions according to an exemplary embodiment of the present invention.

FIG. 44A is an isometric perspective view 4400 of the globe light bulb according to an exemplary embodiment of the present invention.

FIG. 44B depicts an exemplary schematic drawing of an example isolated power driver according to an exemplary embodiment.

FIG. 44C depicts an exemplary top view of an exemplary LED plate for an exemplary globe bulb according to an exemplary embodiment.

FIG. 44D1 depicts an exemplary embodiment of a top side of the an exemplary LED plate for an exemplary globe, according to an exemplary embodiment.

FIG. 44D2 depicts an exemplary embodiment of a bottom side of the an exemplary LED plate for an exemplary globe, according to an exemplary embodiment.

FIG. 44E depicts a schematic diagram of th exemplary

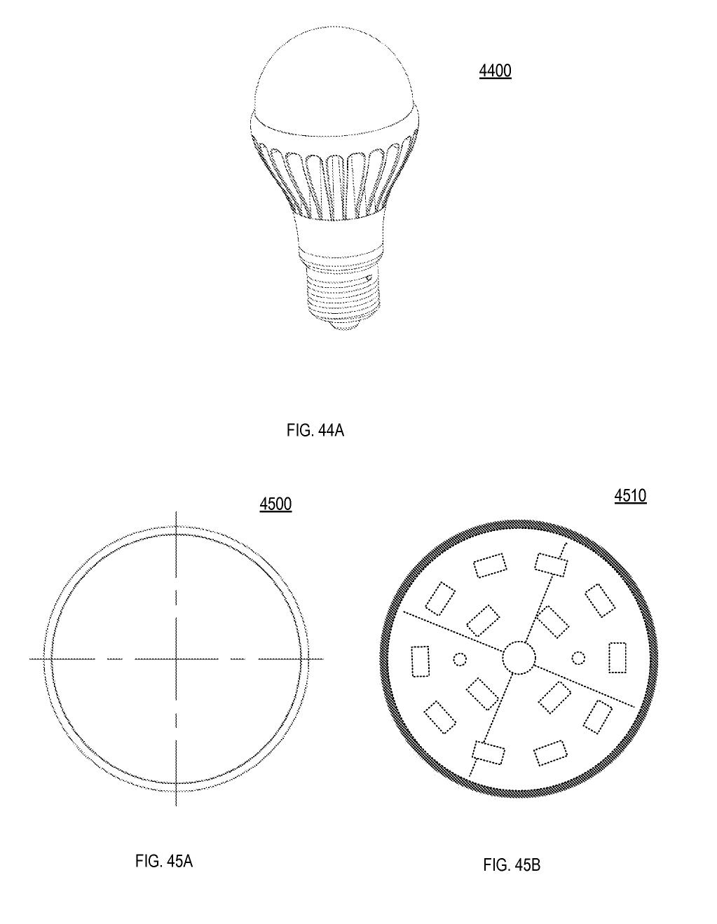

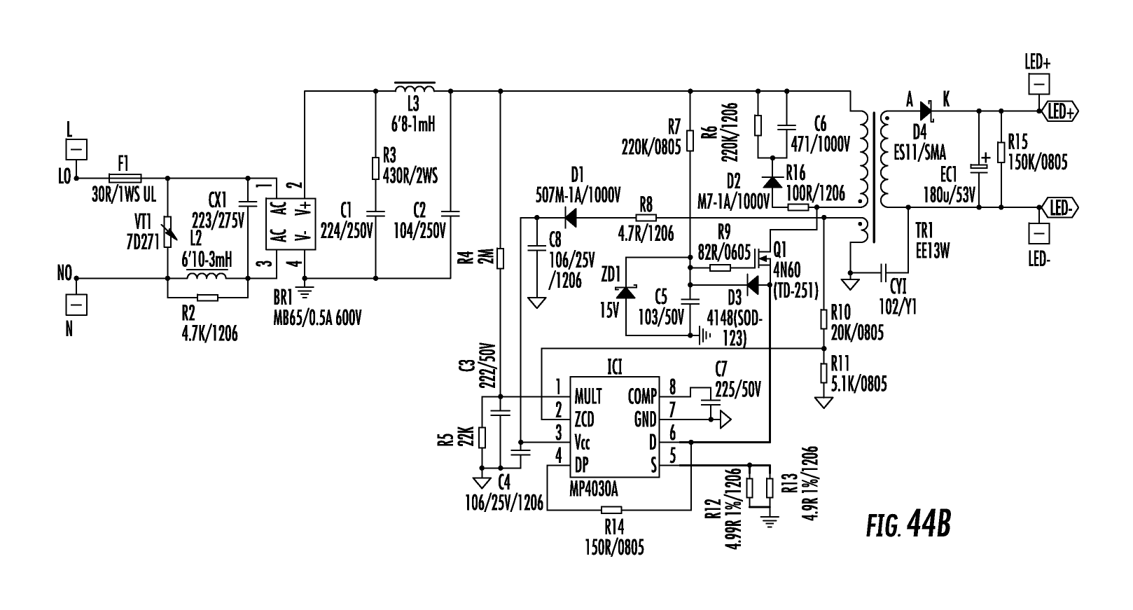

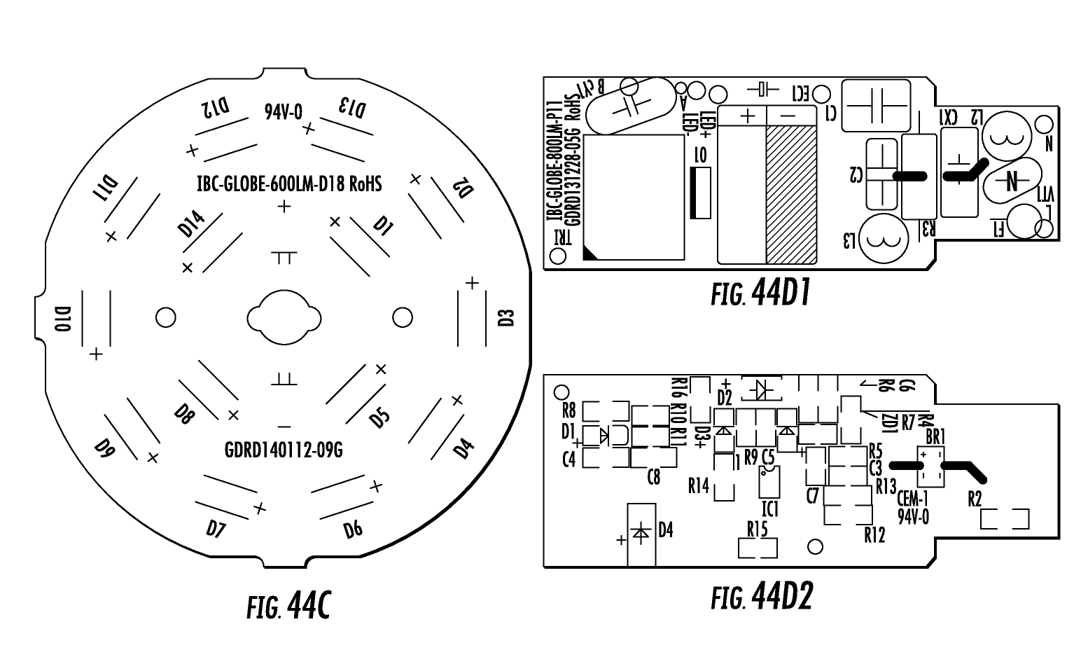

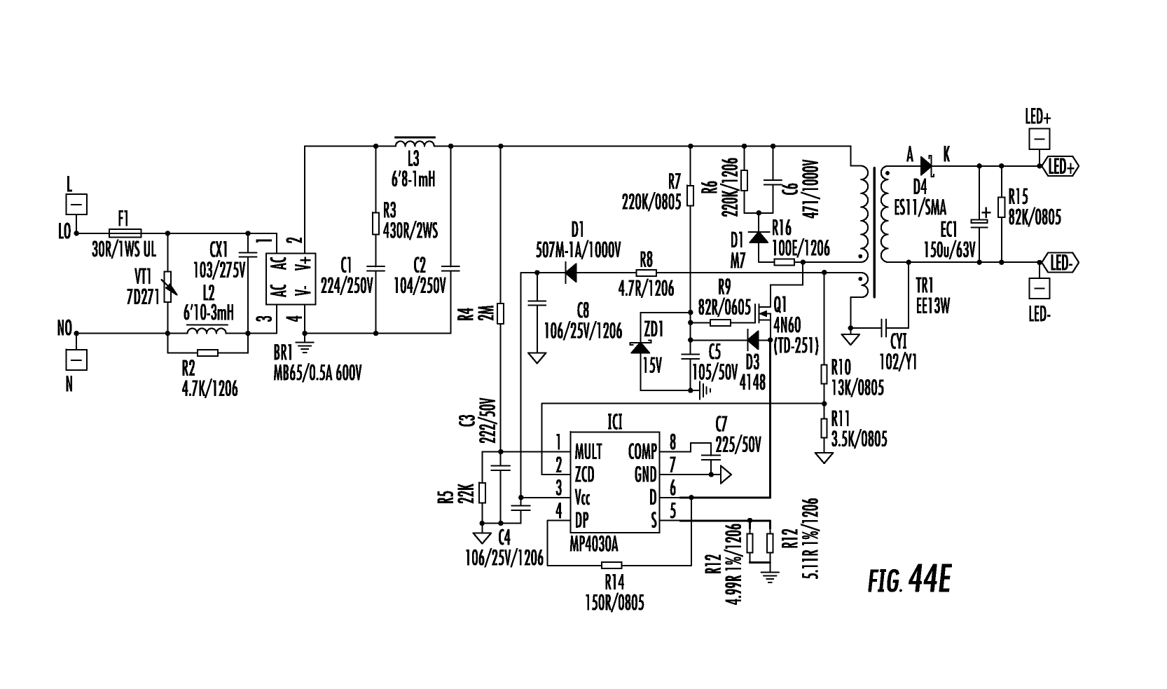

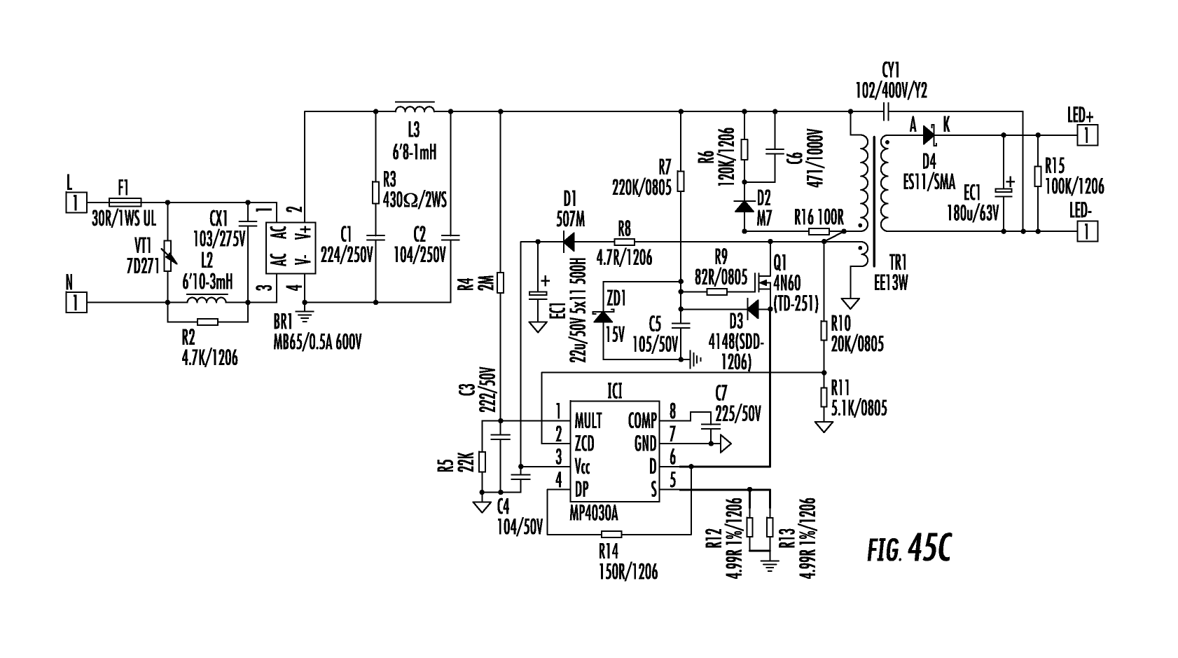

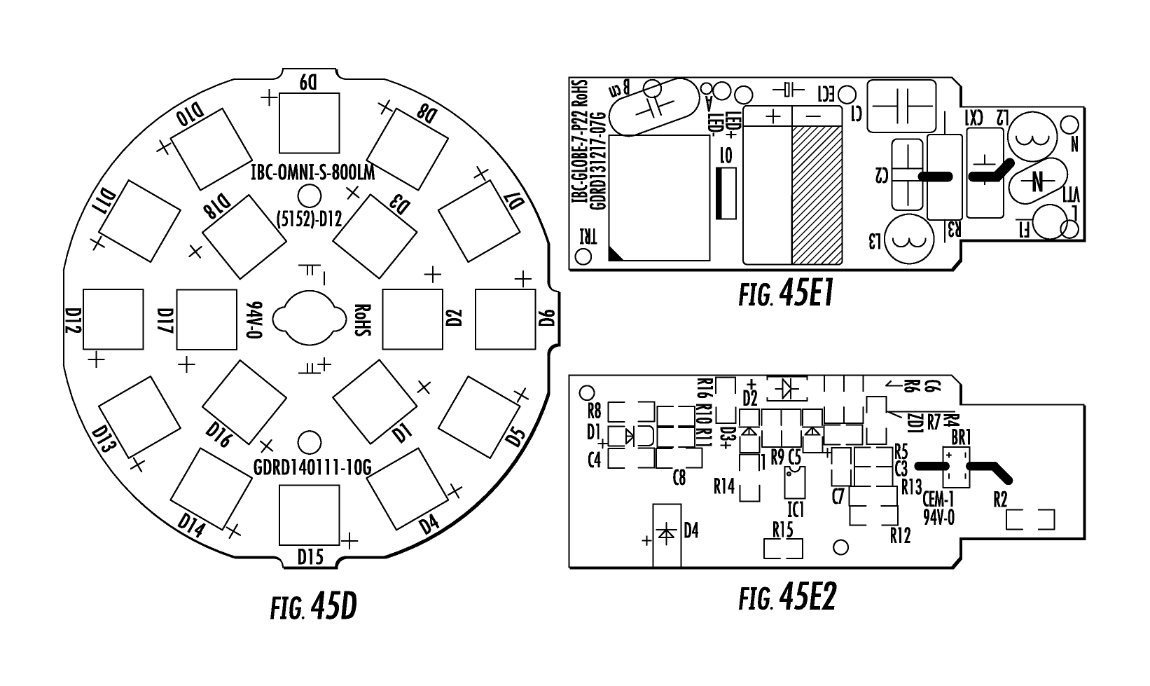

FIG. 45A is a top orthographic view 4500 of the globe light bulb according to an exemplary embodiment of the present invention.

FIG. 45B is a top view 4510 of an exemplary LED package layout for an exemplary globe light bulb according to an exemplary embodiment.

FIG. 45C is an exemplary isolated power driver circuit according to an exemplary embodiment

FIG. 45D is an exemplary top view of an exemplary LED plate for an exemplary omni bulb, according to an exemplary embodiment.

According to an exemplary embodiment, the omni bulb may be referred to as an exemplary all purpose bulb, with an exemplary 800 lumen version, or an exemplary 600 lumen, with about 820 lumens, and about 610 lumens, respectively, according to an exemplary embodiment.

Another exemplary all purpose light may come with either a clear lens, and/or a frosted polycarbonate, as shown, according to an exemplary embodiment.

FIG. 45E1 is an exemplary top view of the power driver, according to an exemplary embodiment.

FIG. 45E2 is an exemplary bottom view of the power driver, according to an exemplary embodiment.

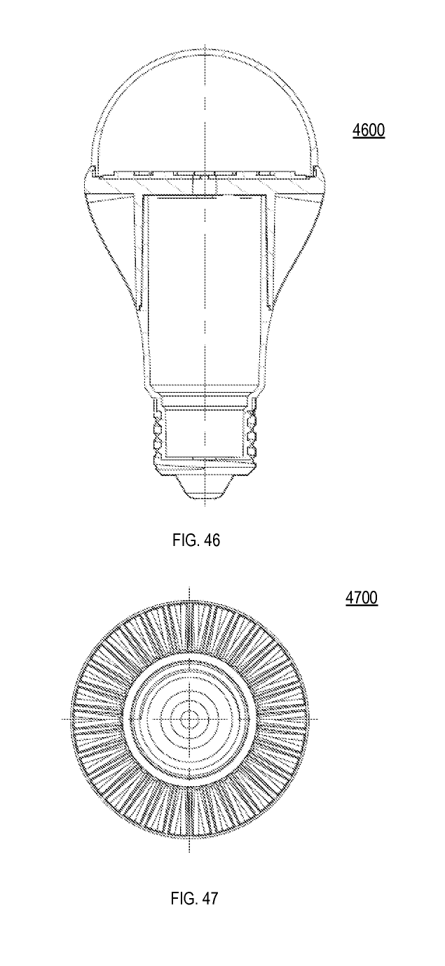

FIG. 46 is an exemplary partial cutaway cross-section view 4600 of the exemplary globe light bulb according to an exemplary embodiment of the present invention.

FIG. 47 is an exemplary bottom orthographic view 4700 of the exemplary globe light bulb according to an exemplary embodiment of the present invention.

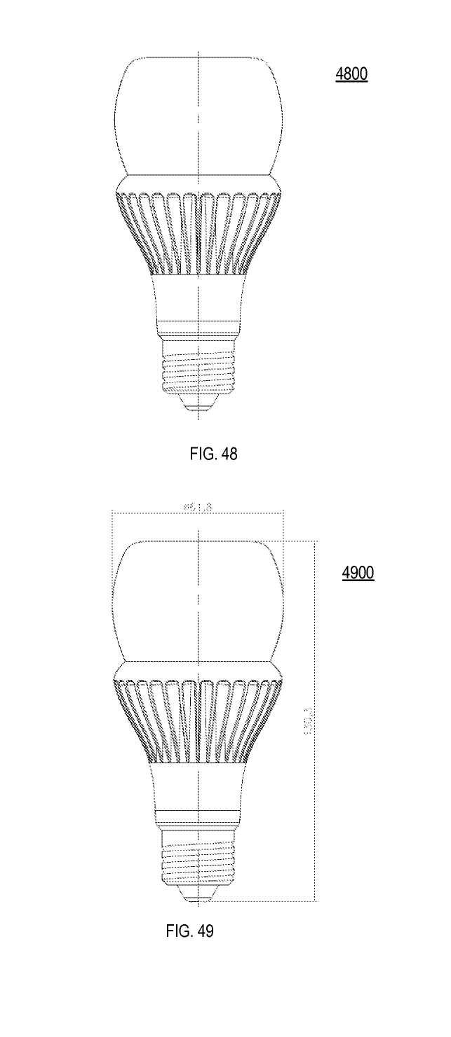

FIG. 48 is an exemplary side orthographic view 4800 of an exemplary omni globe light bulb according to an exemplary embodiment of the present invention.

FIG. 49 is an exemplary side orthographic view 4900 of the omni globe light bulb with exemplary nonlimiting dimensions according to an exemplary embodiment of the present invention.

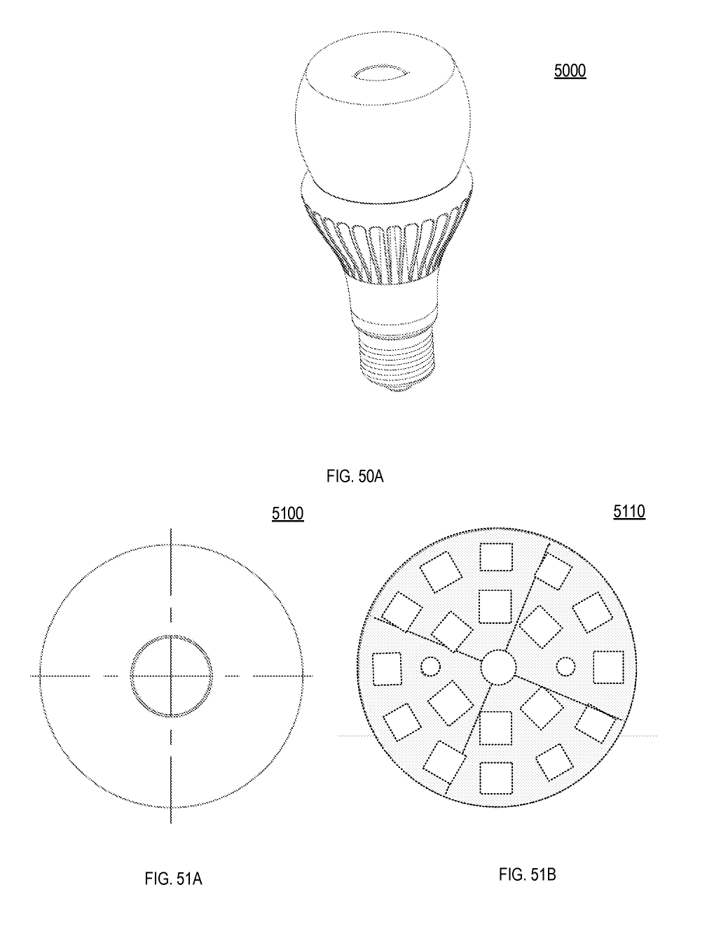

FIG. 50A is an exemplary embodiment of an isometric perspective view 5000 of the omni globe light bulb according to an exemplary embodiment of the present invention.

FIG. 50A depicts an exemplary isometric view of an exemplary omni light bulb, according to an exemplary embodiment.

FIG. 51A is a top orthographic view 5100 of the omni globe light bulb according to an exemplary embodiment of the present invention.

FIG. 51B is a top view 5110 of an exemplary LED package layout for an exemplary omni globe light bulb according to an exemplary embodiment.

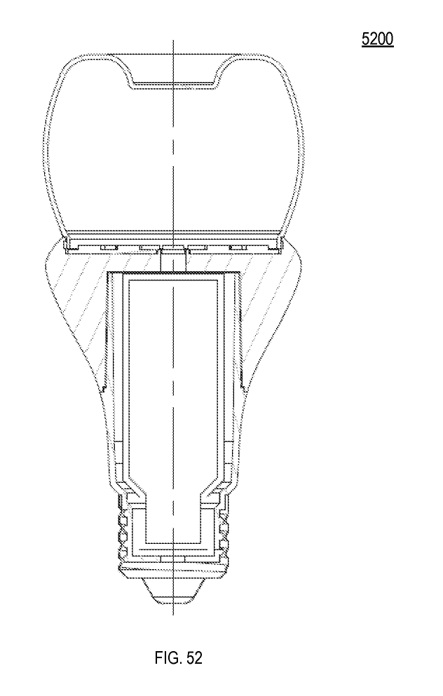

FIG. 52 is an exemplary partial cutaway cross-section view 5200 of the omni globe light bulb according to an exemplary embodiment of the present invention.

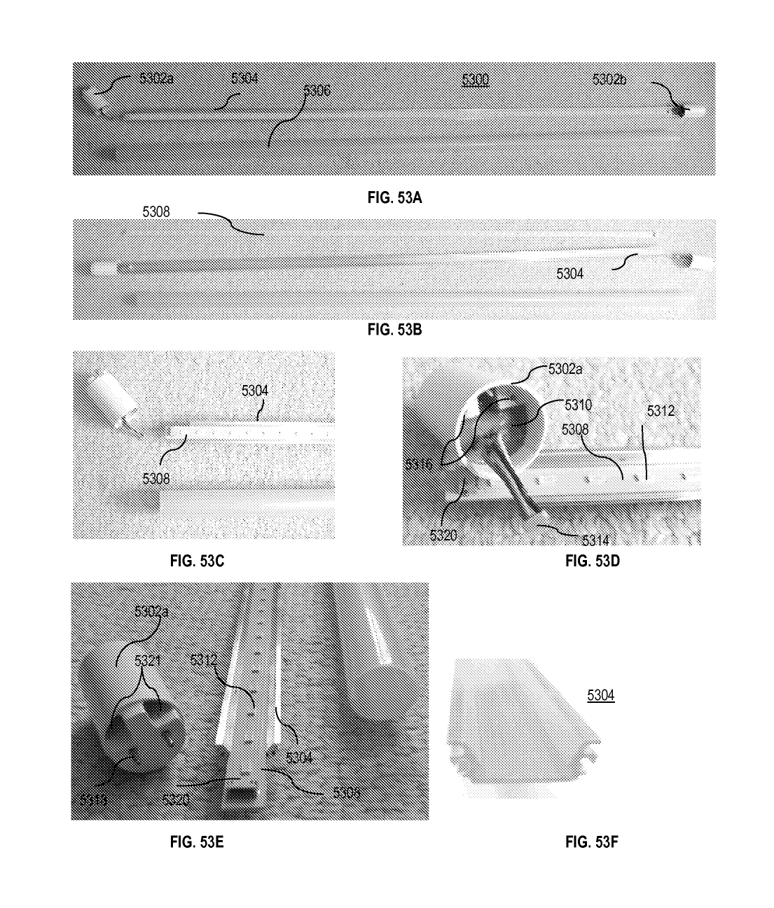

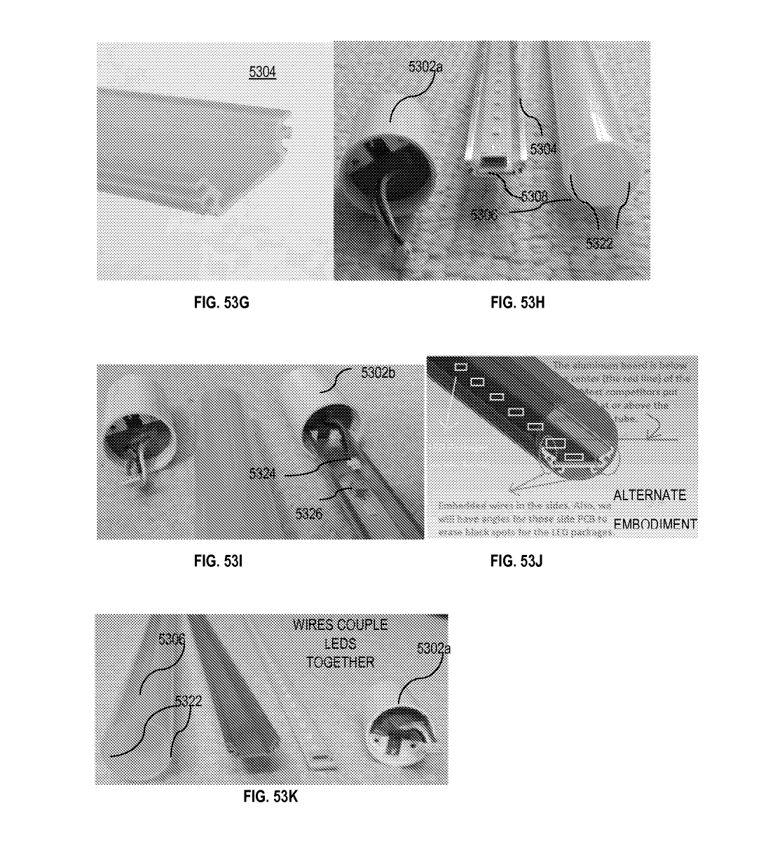

FIG. 53A depicts an exemplary embodiment of an exemplary tube light 5300, disassembled to allow viewing of exemplary components, including, e.g., but not limited to, exemplary first end 5302a and second end 5302b, and/or sideboard 5304, including LED board 5308 (shown in FIG. 53B), according to an exemplary embodiment.

FIG. 53B depicts an exemplary embodiment of the exemplary tube light 5300 of FIG. 53A, disassembled to allow viewing of exemplary components, including, e.g., but not limited to, LED board 5308, disassembled from exemplary sideboard 5304, according to an exemplary embodiment.

FIG. 53C depicts an exemplary embodiment of the exemplary tube light 5300 of FIG. 53A, disassembled to allow viewing of exemplary components, including, e.g., but not limited to, LED board 5308, disassembled from exemplary sideboard 5304, according to an exemplary embodiment.

FIG. 53D depicts an exemplary embodiment of the exemplary tube light 5300 of FIG. 53A, disassembled to allow viewing of exemplary components, including, e.g., but not limited to, an exemplary plurality of light emitting diodes (LED) 5312 affixed upon exemplary LED board 5308, exemplary first end 5302a including an interior end having an exemplary pair of holes 5316 each adapted for receiving a screw from an exterior end (not shown) of the first end 5302a of the tube light 5300, as well as various wires and a first coupler 5314 for coupling to a mating coupler 5320 on the LED board 5308, the first end 5302a shown with advantageous silicone 5310 placed in an opaque cavity to isolate electronic components, where the exemplary LED board 5308 is shown slidably inserted into an exemplary slot of the exemplary sideboard 5304, according to an exemplary embodiment.

FIG. 53E depicts an exemplary embodiment of the exemplary tube light 5300 of FIG. 53A, disassembled to allow viewing of exemplary components, including, e.g., but not limited to, an exemplary plurality of light emitting diodes (LED) 5312 affixed upon exemplary LED board 5308, exemplary first end 5302a including an exterior end illustrating an exemplary pair of electrical couplers 5318, and having an exemplary pair of openings 5321 through which a pair of screws may be placed through holes 5316 shown in FIGS. 53D and 53H, as well as, the mating coupler 5320 on the exemplary LED board 5308, shown slidably inserted into an exemplary slot of the exemplary sideboard 5304, according to an exemplary embodiment.

FIG. 53F depicts an exemplary embodiment of an exemplary end view of the exemplary sideboard 5304 of the exemplary tube light 5300 of FIG. 53A, disassembled to allow viewing of exemplary components, according to an exemplary embodiment.

FIG. 53G depicts an exemplary embodiment of an exemplary edge view of the exemplary sideboard 5304 of the exemplary tube light 5300 of FIG. 53A, disassembled to allow viewing of exemplary components, according to an exemplary embodiment.

FIG. 53H depicts an exemplary embodiment of the exemplary tube light 5300 of FIG. 53A, disassembled to allow viewing of exemplary components, including, e.g., but not limited to, an exemplary tube 5306 having exemplary rail(s) 5322 into which may be slidably placed the exemplary side board 5304, which in turn may include exemplary LED board 5308 slidably placed therein, exemplary first end 5302a is shown decoupled from the mating coupler 5320 (not labeled) of the LED board according to an exemplary embodiment.

FIG. 53 I depicts an exemplary second end 5302(b) and associated coupler 5324 configured to be releasably coupled to exemplary mating coupler 5326, and/or illustrating the end piece coupled to the exemplary LED plate 5308, according to an exemplary embodiment.

FIG. 53J depicts an exemplary embodiment of another exemplary tube LED bulb, according to an exemplary embodiment, which may include, e.g., but not limited to, an LED board placed below a center of the tube, enabling using reflective and embedded side board(s) to reflect light, and may enable using less LED packages than without the reflective side board; an exemplary plastic tube; exemplary embedded wire(s) in, e.g., the side board(s), and/or in the LED board, etc.; an exemplary optional projection to put wires in; an exemplary side board(s) with angles to reflect light; an exemplary printed circuit board (PCB) or LED board, and/or may include, e.g., a single LED board, and/or may be split into 2 or more part(s) and inserted into both sides of the tube, according to exemplary embodiments.

FIG. 53 K depicts an exemplary LED tube 5306, along with exemplary rail(s) 5322 on exemplary interior wall(s) of the tube, according to an exemplary embodiment.

FIG. 53 L depicts an exemplary long LED tube 5306, with exemplary features which may include 48 inch long, 1650 lumens, 16.5 watt, 4100K color temperature, T8 socket, 36.5 year life at 3 hours per day, fluorescent tube replacement bulb, according to an exemplary embodiment.

FIG. 53M depicts an exemplary short LED tube 5306, with exemplary features which may include 24 inch long, 825 lumens, 8.25 watt, 4100K color temperature, T8 socket, 36.5 year life at 3 hours per day, fluorescent tube replacement bulb, according to an exemplary embodiment.

FIG. 53N depicts an exemplary cross-section of an exemplary embodiment of an alternative LED tube 5306, along with exemplary rail(s) 5322 on exemplary interior wall(s) of the tube, according to an exemplary embodiment.

FIG. 53O depicts an exemplary cross-section of an exemplary embodiment of another alternative LED tube 5306, along with exemplary rail(s) 5322 on exemplary interior wall(s) of the tube, according to an exemplary embodiment.

FIG. 53P depicts an exemplary cross-section of an exemplary embodiment of yet another alternative LED tube 5306, along with exemplary rail(s) 5322 on exemplary interior wall(s) of the tube, according to an exemplary embodiment.

FIG. 54A-54D depict various exemplary internal reflectors according to an exemplary embodiment.

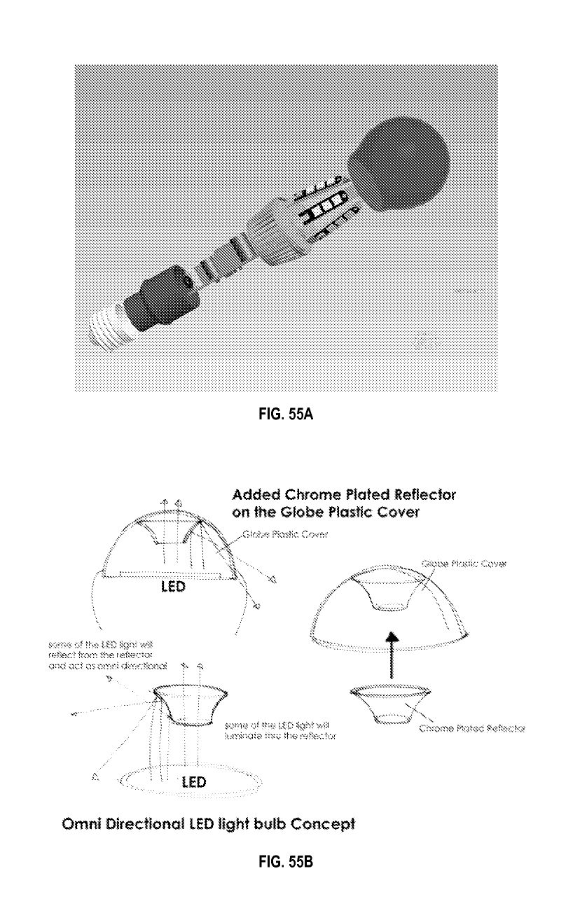

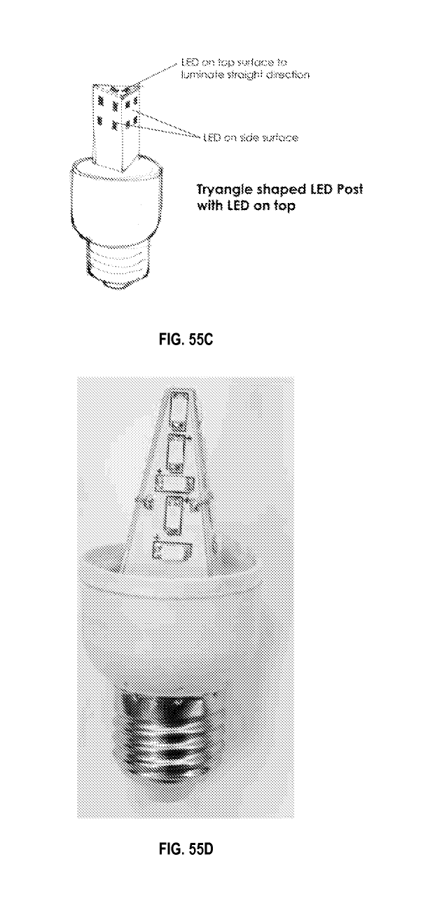

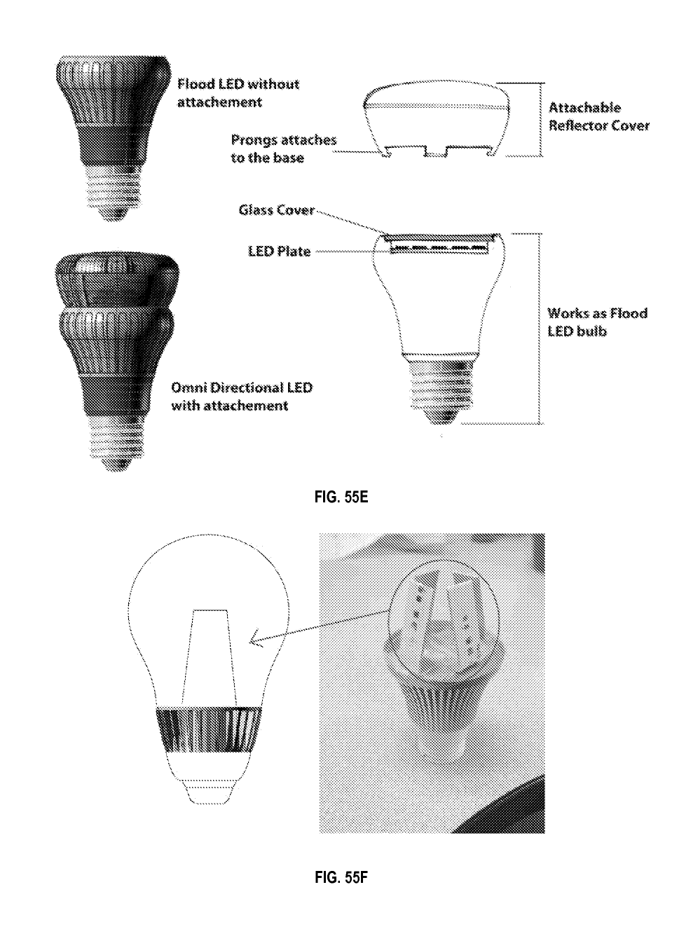

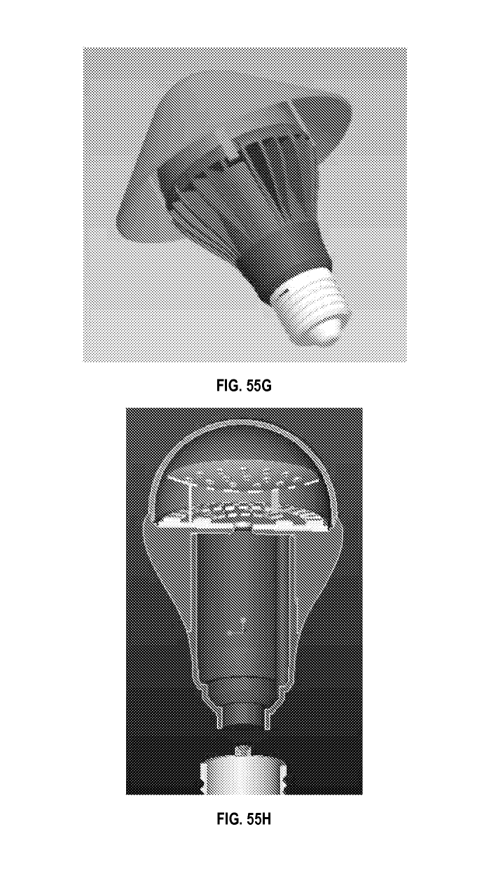

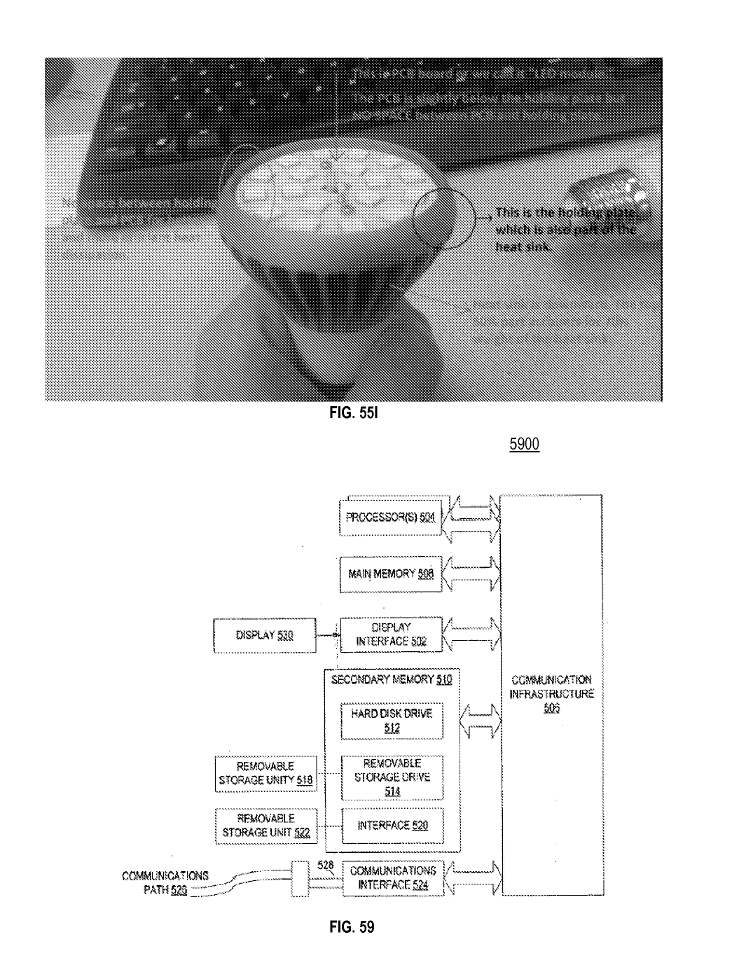

FIG. 55A depicts an exemplary exploded view of an exemplary bent star LED plate unidirectional LED light bulb.

FIG. 55B depicts an exemplary internal reflector according to an exemplary embodiment.

FIG. 55C depicts an exemplary triangular prism LED post according to an exemplary embodiment.

FIG. 55D depicts an exemplary square pyramidal post LED source, according to an exemplary embodiment.

FIG. 55E depicts an exemplary flood light bulb with an exemplary removably or nonremovably, attachable external reflector, according to an exemplary embodiment.

FIG. 55F depicts an exemplary angled bent cross LED plate according to an exemplary embodiment.

FIG. 55G depicts an exemplary light bulb with an exemplary removably or nonremovably, attachable external reflector, according to an exemplary embodiment.

FIG. 55H depicts an exemplary light bulb with an exemplary internal reflector/disperser/diffuser, according to an exemplary embodiment.

FIG. 55I depicts an exemplary image illustrating an exemplary holding plate, which is part of the heat sink, where the heat sink is downward, where the top 50% accounts for 70% weight of the heatsink, the LED module or PCB board is slightly below the holding plate but no space is provided between the PCB and the holding plate, according to an exemplary embodiment. According to an exemplary embodiment, the exemplary heat dissipation part may include a heat dissipation portion which may be coupled to the LED plate, e.g, a ceramic wafer, which may fixed from the internal plate to the outside holding plate as one continuous piece of metal, fixed to the outer edge as shown in various exemplary embodiments, in an exemplary embodiment, for improved heat dissipation. Advantageously, silicone may further be used to fill air pockets and to further isolate the electronic circuitry to prevent direct contact between portions of the circuitry with conductive housing portions

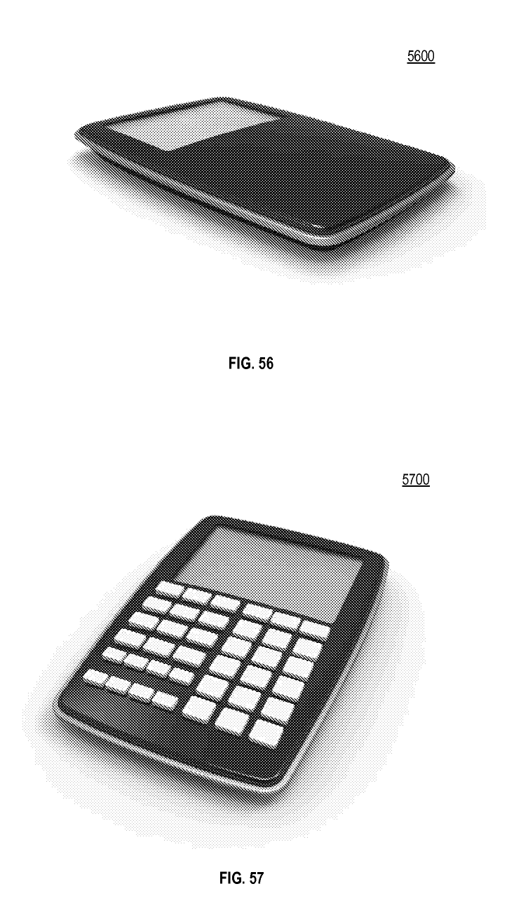

FIG. 56 depicts an exemplary remote control including an exemplary display and/or touchscreen and/or user interface, according to an exemplary embodiment, which may be coupled via an exemplary wireless communications network to control one or more of the exemplary LED bulbs according to an exemplary embodiment.

Exemplary remotes may include lighting controls, which may, according to an exemplary embodiment, e.g., but not limited to, permit lighting control, based on e.g., sensors, so that dimming may automatically be controlled, based on level of daylight, etc., and the controller may adjust to compensate for more or less daylight.

Exemplary daylight sensors may be wall and/or window mountable.

An exemplary daylight sensor, which may also be referred to as an exemplary broad range light sensor, may measure light in the range of an exemplary 200 lux to 10,000 lux, according to an exemplary embodiment.

An exemplary illuminance sensor, which may also be referred to as an exemplary narrow range light sensor, or roomlight sensor, may measure light in the range of an exemplary 100 lux to 2,000 lux, according to an exemplary embodiment.

According to an exemplary embodiment, the sensors may be equipped to communicate with controllers via, e.g., but not limited to, wireless communications such as, e.g., but not limited to Zigbee wireless communication, according to an exemplary embodiment. Exemplary light and/or illuminance sensors may include, e.g., but not limited to, an exemplary one or more LED indicator(s), which may indicate power on/off, power failure, etc., and/or other output devices, and may include e.g., a reset button (e.g., paperclip resettable, push in to reset, etc.), and/or switch, and/or other input devices, and the sensor may include an exemplary programmable microcontroller and/or microprocessor, or other chip and/or communications hardware/firmware/and/or software stack, may include communications chip capability, to communicate with/via a wireless transceiver to an exemplary wireless gateway via exemplary Zigbee protocol, and/or other communications methods as are well known such as, e.g., but not limited to, Bluetooth, Wi-Fi, Wi-Max, UWB, Spread Spectrum, Broadband over powerline (BPL), cableTV (CATV) modulation, etc., as well as, exemplary power input, and/or may include sensing a range of levels such as, e.g., but not limited to, a 0-9 level of 10% increments, and/or a 0-99 level of 1% increments, which may be transmitted to the controller from the exemplary sensor, according to an exemplary embodiment. The unit may be a hanging, desk mount, and/or wall mount and may include an exemplary disk shaped sensor, which may include an exemplary polycarbonate disk or other protector for the sensor, according to an exemplary embodiment.

Exemplary LED bulbs and/or lighting fixtures may be outfitted with exemplary wireless communication transceivers permitting wireless control of the bulbs and/or fixtures. Exemplary embodiments may include an IEEE 802.15.4 wireless transceiver compliant in an exemplary embodiment with the Zigbee protocol. Various exemplary fixtures may include exemplary pulse wave modulation (PWM) controllable dimmer driver circuits, which according to an exemplary embodiment may permit dimming in 1% increments from 0% to 100%, according to one exemplary embodiment. According to an exemplary embodiment, a power driver may be able to convert 120V or 277V AC current to 10-18 V DC current in the exemplary driver. Driver housings, according to an exemplary embodiment may be completely filled with silicone to permit isolating electronic components from exemplary metal housing, or other components, to reduce or eliminate risk of shock from unintended short circuits.

An exemplary wireless communication adapted apparatus may be configured to upon power up send out a registration of its address to register itself with a wireless gateway. An exemplary 12 inch cord with an electrical plug on one end may be used to register a device, and then after registration by powerup by plugging into an outlet, the cord may be unplugged from the device and the device may then be ready for final install.

An exemplary ethernet gateway may include an ethernet port for coupling to an ethernet router, and may support up to an exemplary 600 units to 20,000 units to allow communication/control of the various lighting apparatuses via wireless control using the Zigbee protocol, e.g., IEEE 802.15.4, or the like, etc.

Alternative embodiments may use other protocols such as, e.g., but not limited to, Wi-Fi, Wi-Max, BlueTooth, and/or other wireless communications protocol, as will be apparent to those skilled in the relevant art.

Certain devices may be provided with a reset button on an exemplary apparatus or fixture, permitting reset of an exemplary apparatus or fixture.

Certain exemplary fixtures may be provided for commercial use including, e.g., but not limited to, a troffer, a troffer hung by chain or pin, a high bay, a low bay, a canopy version, a chained or pendant version, down lights, down lights in a custom can or a kit in a standard off the shelf downlight can, etc., according to an exemplary embodiment.

Certain versions may be adapted for use in humid environments, such as, e.g., but not limited to, misting rain, blowing snow, food processing plants, gas stations, etc., by including exemplary sealing rings.

Certain versions may include an exemplary diecast steel and/or other sheetmetal housing, mayh include an exemplary hole in the exemplary housing through which an electrical conduit may pass through, an exemplary junction box which may include space to permit coupling the lighting device to the exemplary fixture. the exemplary fixture may include a heat dissipator, an exemplary cylinder housing portion for housing an exemplary driver circuit, one or more LED plates, such as, e.g., but not limited to, four (4) and/or 6 sector shaped partial annular ring shaped plates surrounding an exemplary high bay and/or low bay, each of the exemplary LED plates with a plurality of LED plates thereon, an exemplary lens such as e.g., an exemplary polycarbonate exemplary clear and/or frosted lens, with an exemplary A12 pattern exemplary diamond shaped prism, and exemplary bottom fixture which can protect the LEDs modules from being contacted by water and/or other liquids. Exemplary LED plates may be ceramic plates, which may be a wafer with LEDs mounted to the wafer.

Exemplary residential LEDs may be provided with a warm 3000 kelvin color, while an exemplary commercial light may include an exemplary 4000 kelvin cool white color, according to an exemplary embodiment. Further, exemplary lighting fixtures may include a color rating index (CRI) of about 780, a measure of how well the lighting fixture will maintain its color over the life of the lighting device, approximately 86-88, and potentially 90 or greater, according to an exemplary embodiment.

An exemplary troffer light may be approximately 2 feet by 4 feet rectangular in exemplary shape with exemplary 5000 or 8000 lumen versions for recessed troffers, according to an exemplary embodiment, or 8000-14000 lumen exemplary versions for chain or pin hung troffers.

An exemplary canopy light may include an exemplary 2 feet by 2 feet and approximately 5,000 or 8,000 lumen versions, according to an exemplary embodiment.

An exemplary low bay light may be about 20 inches in diameter, in an exemplary embodiment, and an exemplary approximately 14,000 lumens.

An exemplary high bay may be approximately 24 inches in diameter, i.e., about 3-4 inches greater in diameter than an exemplary low bay, and may support an approximate 18,000-26,000 lumens, etc., according to an exemplary embodiment.

Exemplary downlight embodiments may include, e.g., but not limited to, 600 lumen, 1000 lumen, 1400 lumen, and/or 4 inch and/or 6 inch version kits, which may include a piece including an exemplary trim, lens, LED, and driver, according to an exemplary embodiment. An exemplary embodiment may support an adapter to screw into a socket, and the kit may be placed into a remarked can from various vendors. An exemplary downlight may include a DLC and/or Energy Star compliant versions.

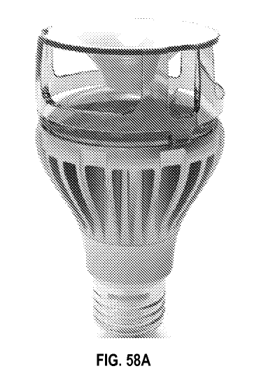

FIG. 57 depicts an exemplary remote control including an exemplary display and/or touchscreen and/or user interface and/or optional buttons and/or optional keys, according to an exemplary embodiment, which may be coupled via an exemplary wireless communications network to control one or more of the exemplary LED bulbs according to an exemplary embodiment.

An exemplary algorithm may include the following:
Remote On/Off-->Jenny 4/4/14: Display On/Off

Wake up remocon from safe mode. If no touch key button for 60 sec, the remocon will go into safe mode, and LCD & light signal will off. If user needs to use remocon, he must press Display On/Off key, and then remocon works. Otherwise, other keys are not effective.

Press Display On/Off, signal lights is green, and LCD display current clock.

[symbol] :

100%

100%

“Power”

Remark:

If turn on bulbs by wall switch, all bulb shall be 100% On.

If turn off bulbs by wall switch, all bulb shall be 100% Off.

After wall switch is on, and then “Display On/Off” remocon, bulbs will perform the program (if has) as it was setup for current time until wall switch is off
ALL:

ALL, START,
To choose All bulbs.
Ex. Press All, and press Start, then all bulbs will be on.
GROUP:
GROUP, START, (100%)
To choose group.
Ex. Group->number->Start. This group will be 100% on.
BULB:
30
Bulb->2->Bulb->3->Off. 2 3
Bulb->2->OK->Bulb->3->Off
To choose bulb.
Ex. Bulb->2->Bulb->3->Off. Then bulb 2&3 will be off.
Or, Bulb->2->OK->Bulb->3->Off. Bulb 2&3 will be off.
START TIME:
Set up start time for certain function.
END TIME:
Group->5->Start Time->Day->2->OK->08:00->AM->End Time->Day->2->10:30->AM->Start, 8, 10:30, 100%.

Set up end time for certain function.

Ex. Group->5->Start Time->08:00->AM->Day->2->OK->End Time->10:30->AM->Day->Day->OK->Start, then group 5 will be 100% On during Tuesday 8:00 am-10:30 am.

Jenny 4/4/14: If you pressed “Start time” or “End Time” button, then you need to enter the number of time as above. After that, we can press “Day” or Function button. If you pressed “Day” first, then choose day and then press “Start or End time”.

100%
If no input day, but input start time & end time, then default as every day from start time to end time.
If no input time, but input day, then default as 00:01 am˜11:59 pm at that day.
If input start time & day, and input end time, no day, then default as start time to end time at same day as input.
If no input function, then default 100% dimming.
If input function, then perform as it's set up.
DIMMER:
1˜100% 100%.
: Group->3->Start Time->Day->2->OK->08:00->AM->End Time->Day->Day->OK->10:30->AM->Dimmer->80->Start. 8:00 10:30 80%.

Set up the dimming percentage, 1˜100%. Default is 100%.

Ex. Group->3->Start Time->08:00->AM->Day->2->OK->End Time->10:30->AM->->Day->Day->OK->Dimmer->80->Start. Then group 3 will be 80% on during Tuesday 8:00 am-10:30 am.
FOOT CANDLE:

200, 400, 600, 800, 1200, 1400, 1600, 1800, 2000, 2000.
LIGHT SENSOR:

1˜100, 100 1˜100 10
: Group->8->Light Sensor->20->Start.

20 0 100%, 0%.

Determine whether to turn on/off the bulbs. Set up 1˜100. Default is 100. 10 is darkest, 100 is brightest. 1˜100 means brightness lever, not actual brightness. Totally user can choose 10 levers, every 10 for 1 lever. So option 10, 20, 30, 40, 50, 60, 70, 80, 90, 100.

Ex. Group->8->Light Sensor->20->Start. Then group 8 will be 100% ON when light sensor sensed the brightness is less than 20's level, group 8 brightness is turned from 0˜100% gradually in 10 seconds. If the light sensor sensed the brightness is more than 20's level, then group 8 will be off from 100% to 0% gradually, in 10 sec.
Motion in, Motion out, Hold Time
100%
: Group->7->Motion in->90->Hold Time->10->Motion out->30->Start. 90%, 10 30%.
Group->7->Motion in->Start. 100%,

When motion sensor sensed anybody or car moved in, then bulb will be ON, default dimming 100%, default time is 5 minutes. When it cannot sense any movement for 5 minutes, default as Off, or operate as program.

Ex. Group->7->Motion in->90->Hold Time->10->Motion out->30->Start. Then, if anybody/car walked in group 7 area, all bulbs of group 7 will be 90% on. After it cannot sense any movement in 10 minutes, group 7 will be Off (or operate as programmed).

Jenny 4/4/14: How about the “Motion out->30”? It sensed after 15 min. from the hold time, how does work?

it should be 30% on from the motion out or 90% on from the motion in?
Clock
Clock->08:00->AM->Day->3->Start. 8

Clock

Set up current clock.

Clock->08:00->AM->Day->3->Start. Then current clock is Wednesday 08:00 am.

User has to input time first and then day. 4 digits of LCD will be blinking when you press “Clock” button.

Clock information will be sent and stored in gateway once it's setup.
AM/PM
AM/PM, START

Set up AM/PM
DAY

Day+1=

Day+2=

Day+Day=

Day+1+2+3+4+5,

Day+1+Day+2+Day+3+4+Day+5 Day+1+2+3+4+5+2+4,

“Day”, 1, OK, Mon. [symbol] Mon [symbol] , [symbol] , [symbol] Mon [symbol] .

Set up day.

Day+1=Monday

Day+2=Tuesday

Day+Day=Tuesday

Day+1+2+3+4+5, or Day+1+Day+2+Day+3+4+Day+5, then Mon˜Fri are selected.

Day+1+2+3+4+5+2+4, then only Monday, Wednesday and Friday are selected. Double selected day will disappear.

If you press “Day”, then “Mon” will be blinking. If you press 1 or press “OK”, then choose Mon. After choose Monday, Press “1” again then “Mon” will disappear.
New
100

Make program. Minimum, user is able to input 100 pcs of program.
Save
25

New->Object->Time (Day->Time, or Time->Day)->Function->Save->number->save.

Off

Save program

New->Object->Time (Day->Time, or Time->Day)->Function->Save->number->save.

If no choose object, then default as All.

If no choose Time, then default as from now, until anybody changes it.

If no choose function, then default as “OFF”

In each program, max user can setup 25 pcs of functions at the same time.
RECALL
Recall->5->Start.

Recall->5->OK. Save->any number->Save. Delete

Save->29->Save, 29

Save->29->Save->Start, 29

Delete

Save

Save->29, Delete,

Save->29->Save, Delete, 29

Display/revise/start program which already been saved.

Recall->5->Start. Execute program 5.

Recall->5->OK. Display program 5. According to displayed program, user can revise it. After revision, press Save->any number->Save. User can quit this revision by press Delete.

Jenny 3/25/14: “any number”-->If you press “5” then it will be over writing the program.
If you press any other number than “5” then, it will be save as a new program.
And it will be kept Program 5 as original setting.
Example) Recall->5->OK-->Changed function->Save->5->Save
Saved with changed function at the Program 5.
Recall->5->OK-->Changed function->Save->29->Save
Saved with changed function at Program 29 and also keep the program 5 as original setting without any changed function.
Recall->5->OK-->Changed function->Save->29->Save->Start
If you press “Start” button after changed & saved program, then “program 29” will be executed.

“User can quit this revision by press Delete-->This Delete key should be works before press 2nd time of “Save” button, which means “Save”->5->Delete: it should be worked.

However, it should not be worked after press second time of “Save” button. Which means “Save”->5->Save->Delete: it should not work.

“Recall”, “G4”

P005.

All, Group, Bulb. G001, G002, B001, B002

LCD
When you press “Recall”, “G4” will be blinking
Then it display program# like P005.
Then it display object, like “All”, or “Group”, or “Bulb”, and selected objected # will be displayed as like G001, G002, or B001, B002 etc. display will change every 1 sec.
Then it display function.
LCD changes display for each stage by 5 sec.
If you press arrow at any time during changes display, then can go back and force.
If you didn't press arrow or any other order within 15 sec, it will go back to show automatically.
Program modification, can only modify number information, cannot modify, delete or add function.
DELETE
DELETE

DELETE, OK,

Delete the program.

Ex. Delete->5 (already saved this program before)->Delete->OK. Then this program will be deleted.

New->All->Start Time->Day 2->0800 am->Auto In->Save->5->Delete,

[symbol] Group->5->Light sensor->Delete, [symbol] [symbol] .

[symbol] New->All->Start Time->Day 2->0800 am->Auto In->Save->5->

Save->Delete, 5

Delete->5->Delete->OK. 5
Group->5->Light sensor->Start,

Cancel all previous input.

Ex. New->All->Start Time->0800 am->Day 2->Auto In->Delete, then all input will be cancelled.

Group->5->Light sensor->Delete, then all input will be cancelled.

New->All->Start Time->0800 am->Day 2->Auto In->Save->5->Save->Delete, then previous input cannot be cancelled. This program has been saved as program 5. If user need to delete the program 5#, he has to press Delete->5->Delete->OK.

Group->5->Light sensor->Start, then previous input cannot be cancelled, because this order has been sent out.

20, ALARM
ALL START TIME, END TIME, ALARM, START,

Bulbs turn on 100% On when motion sensor detected movement.

Ex. All->Start Time->0800->PM->Day->OK->End Time->0700->AM-Day->2->OK->Alarm->OK. Then if anybody breaks in during Monday 08:00 pm to Tuesday 07:00 am, if any motion sensor sensed movement, all bulbs will be 100% on.

Jenny 3/25/14: Depends on “Day” function on page 2.

22, CANCEL
CANCEL

Cancel the input.

Press one time “Cancel”, cancel last one input.

Press twice “Cancel”, cancel last two input.

23. Manual Config.

[symbol] [symbol] , [symbol] [symbol] , [symbol] Manual Config [symbol] [symbol] , [symbol] Manual Config [symbol] , [symbol] [symbol] Manual Config [symbol] , [symbol] , [symbol] Manual Config [symbol] .

Press Manual Config., and it enters into manual function.

If it's already Manual Config., and press “Manual Config.”, it will quit Manual Config.

and returned to auto mode as default mode.

“Manual Config.” 5,

All->Motion in->Start. “Motion in”

“Manual Config.”, 5.

Remark:

As default, it operates as auto mode. Auto mode is running program only.

After switch into Manual Config., it operates as manual input order only.

Therefore, in case you're running program 5 now, and you switched to Manual Config., and input All->Motion in->Start. Then all bulbs will be under “Motion in” function until somebody gives new order to it (or wall switch is off). And after you press “Manual Config.” again, it will return to auto mode, and runs program 5.

5# (all light sensor 70), Group 3, Off, Group3

If all bulb are running program 5# (All light sensor 70), then user enter into manual config, and order Group 3->Off, then group 3 will be off immediately, until it receives new manual order, or user quit manual config, or user power off wall switch and then power on wall switch. other bulbs will still run program 5 (light sensor 70).

On

On. [symbol] [symbol] , [symbol] [symbol] , [symbol] [symbol] .

Turn on bulbs.

Object->Time->On.

Then the chosen bulbs will be on.

If no input object and time, then default as turn on all bulbs immediately, until somebody orders other function. Or power off wall switch.

Off

Off

Off

Object->Time->Off.

Then the chosen bulbs will be off.

If no input object and time, then default as turn off all bulbs immediately, until somebody orders other function. Or power off wall switch, and then turn on.

100

50

24

4

5, 24 Off.

6, 25

7, PC

PC 8, USB 9, Clock

12,

13, Foot candle Dimming., Foot candle

14, Foot candle light sensor.

15, candle foot candle 100%

16, All->Motion In->Foot Candle 80->Start.

foot candle 80.

Remark
Gateway can save minimum 100 pcs program.
Due to limitation of gateway memory, user can make max 50 groups.
Program input order: object+time (day, time or time, day)+function. If no day input, then default as Monday to Sunday; if no time input, then default as 24 hrs. if no day & no time input, it will be repeated Monday to Sunday as 24 hrs every day.
User is supposed to set up all function in all day long for 24 hrs and 7 days. if user forgot to set up function in certain period, then default it as off
At the same time, max input bulb/group number is 30 pcs.
In one program, max can input 25 pcs of function.
Only in PC, user can setup network, bulb read, bulb rename and group. And user can change bulb name or group in PC anything they want.
Remocon will use dry battery, which users shall purchase by themselves. No USB cord will be used on remocon.
In gateway, button battery will be used to backup clock. If clock is incorrect in remocon, user can set up by Clock key, and gateway's clock information will be renewed once it's setup in rermocon.
The gateway data will not lose even though it's power off suddenly.
All data shall be stored in IC of gateway, as long as IC in gateway works normal, all data is alive. User should be able to unsoldering the IC and apply it to another gateway to continuously use.
No switch in gateway.
User cannot setup foot candle & dimmer at the same time. If setting at the same time, foot candle has priority.
User cannot setup foot candle & light sensor at the same time.
When it's running foot candle function, if foot candle suddenly doesn't work, then the chosen bulbs will be default as 100% on.
All->Motion In->Foot Candle 80->Start. Means, when people/car moves in, all bulbs will run as foot candle 80.

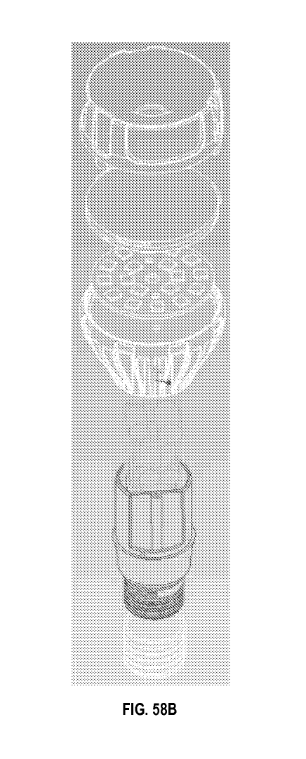

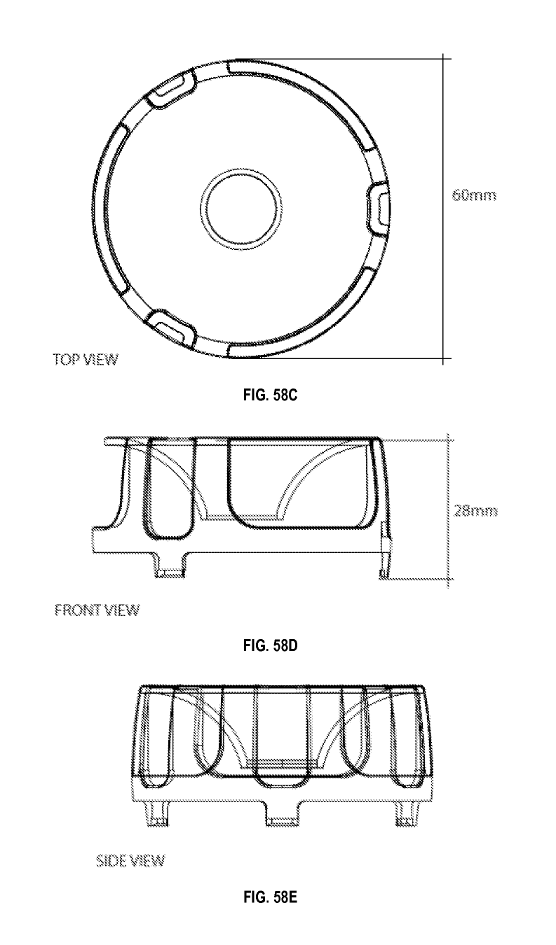

FIG. 58A depicts an exemplary globe LED light bulb, which may include exemplary brightness of 850 lumens, 9 watts energy usage, exemplary 3000K color temperature, standard E26 socket size, a lifetime of 36.5 years at 3 hours of usage per day, 85 watt incandescent replacement, may be used as a directional spot light bulb without reflector attached, or may be used as an omnidirectional light bulb with exemplary reflector attached, according to one exemplary embodiment.

FIG. 58B depicts an exemplary exploded view of an exemplary embodiment of the exemplary globe LED bulb, according to an exemplary embodiment.

FIG. 58C depict an exemplary orthographic top view of an exemplary exterior diffuser/reflector, with exemplary nonlimiting dimensions, according to an exemplary embodiment.

FIG. 58D depict an exemplary orthographic front view of exemplary exterior diffuser/reflector, with exemplary nonlimiting dimensions, according to an exemplary embodiment.

FIG. 58E depict an exemplary orthographic side view of an exemplary exterior diffuser/reflector, with exemplary nonlimiting dimensions, according to an exemplary embodiment.

FIG. 59 depicts an exemplary diagram 5900 illustrating an exemplary computer/communications device hardware architecture as may be used in various components of exemplary embodiments of the present invention. FIG. 59 depicts an exemplary view 5900 of an exemplary computer system 102, 104, 112 as may be used in implementing an exemplary embodiment of the present invention. FIG. 59 depicts an exemplary embodiment of a computer system that may be used in computing devices such as, e.g., but not limited to, capture device 102, aggregation device 104, and/or server/consolidator device 112 according to an exemplary embodiment of the present invention. FIG. 59 depicts an exemplary embodiment of a computer system that may be used as client device 108, or a server device (not shown), etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 59 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A, OS/2 from IBM® Corporation of Armonk, N.Y, U.S.A, Mac/OS from APPLE® Corporation of Cupertino, Calif., U.S.A, etc, or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPhone, a smartphone, an iPad, a tablet based device, an ANDROID OS device, an iOS device, a Symbian based device, a Windows 8 device, etc., may also be implemented using a computer such as that shown in FIG. 59.

The computer system 5900 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 5900 may include a display interface 502 that may forward, e.g., but not limited to, graphics, text, and other data, etc., from the communication infrastructure 506 (or from a frame buffer, etc., not shown) for display on the display unit 530.

The computer system 5900 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 5900. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 5900.

Computer 5900 may also include an input device such as, e.g., (but not limited to) a mouse or other pointing device such as a digitizer, and a keyboard or other data entry device (none of which are labeled).

Computer 5900 may also include output devices, such as, e.g., (but not limited to) display 530, and display interface 502. Computer 5900 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the present invention as discussed herein. In particular, the computer programs, when executed, may enable the processor 504 to provide a method to resolve conflicts during data synchronization according to an exemplary embodiment of the present invention. Accordingly, such computer programs may represent controllers of the computer system 5900.

In another exemplary embodiment, the invention may be directed to a computer program product comprising a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11 compliant wireless local area network (LAN), 802.16-compliant wide area network (WAN), Zigbee wireless, 802.15-compliant wireless network, and/or ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11 a, b, d and g, (including, e.g., but not limited to IEEE 802.11g-2003, etc.), etc. In an exemplary embodiment, an exemplary Zigbee wireless transceiver may be used, which may be used to address a wide range of exemplary IEEE 802.15.4-compliant devices and network elements.

While various embodiments of the present invention have been described above, it should be understood that they have been presented by way of example only, and not limitation. Thus, the breadth and scope of the present invention should not be limited by any of the above described exemplary embodiments, but should instead be defined only in accordance with the following claims and their equivalents.

1. A light emitting diode (LED) lighting apparatus comprising:
a socket;
a power driver electrically coupled to said socket;
an LED plate comprising a plurality of LEDs, electrically coupled to said power driver;
a holding plate having an internal surface and an external surface adapted to dissipate heat, and disposed proximate to said LED plate; and
a cover coupled to said holding plate.

2. The LED lighting apparatus according to claim 1, wherein said power driver comprises an isolated power driver.

3. The LED lighting apparatus according to claim 2, wherein said isolated power driver comprises:
a housing isolating conductive components from contact with conductive components, or a user of the LED lighting apparatus.

4. The LED lighting apparatus according to claim 3, wherein said conductive components comprise at least one of:
a metallic component;
a semiconductor component;
an alloy material component; or
a non-metallic component.

5. The LED lighting apparatus according to claim 1, wherein the holding plate comprises at least one upper portion having a diameter greater than at least one lower portion.

6. The LED lighting apparatus according to claim 2, further comprising at least one of:
a silicone cavity filling of any air pockets of the LED lighting apparatus so as to prevent movement of components an wires to reduce or eliminate shock risk; or
a silicone based cavity filling material to eliminate air pockets around said power driver.

7. The LED lighting apparatus according to claim 1, wherein said holding plate comprises at least one of:
at least one fin;
at least one rib;
at least one fin external to the apparatus; or.
at least one rib internal to the apparatus.

8. The LED lighting apparatus according to claim 1, wherein said holding plate comprises a solid aluminum plate with no air gap, surrounding the LED plate.

9. The LED lighting apparatus according to claim 1, wherein the LED lighting apparatus comprises at least one of:
a desk lamp bulb;
a vanity bulb;
a tube bulb;
a flood light bulb;
a candle bulb;
an omnidirectional bulb;
a globe shaped bulb;
a cylindrical tub shaped bulb;
a globe shaped cover bulb; or
a omnidirectional bulb comprising at least one concavity.

10. The LED lighting apparatus according to claim 1, further comprising:
at least one reflector plate.

11. The LED lighting apparatus according to claim 1, further comprising:
at least one internal rib plate.

12. The LED lighting apparatus according to claim 1, further comprising a pulse width modulation (PWM) dimming method.

13. The LED lighting apparatus according to claim 12, wherein said PWM dimming method is configured to dim between 0-100 in up to 20% increments of granularity.

14. The LED lighting apparatus according to claim 12, wherein said PWM dimming method is configured to dim between 0-100 in 1% increments of granularity.

15. The LED lighting apparatus according to claim 1, further comprising:
a wireless communication chipset electrically coupled to the bulb.

16. The LED lighting apparatus according to claim 15, wirelessly coupled to a gateway.

17. The LED lighting apparatus according to claim 15, wherein the wireless communication chipset communicates by at least one of:
a wireless local area network;
a wireless wide area network;
a wireless fidelity (WiFi) protocol;
a WiMax protocol;
a bluetooth protocol;
a broadband over powerline (BPL) communication method;
a cable television connection; or
a zigbee protocol.

18. The LED lighting apparatus according to claim 15, further comprising at least one of:
a remote control device configured to communicate with the wireless gateway;
a smartphone device and application program configured to communicate with the wireless gateway;
a wall mounted device configured to communicate with the wireless gateway; or
a stationary device configured to communicate with the wireless gateway.

19. The LED lighting apparatus according to claim 1, wherein said power driver comprises:
an inverter configured to transform alternating current (AC) power to direct current (DC) power.

20. The LED lighting apparatus according to claim 19, wherein the LED lighting apparatus is configured to reduce or eliminate risk of shock by isolating all electronic components on the AC side of said inverter.

21. The LED lighting apparatus according to claim 1, further comprising at least one of:
a light sensor;
a luminance sensor;
an illuminance sensor;
a daylight harvesting sensor; or
a sensor.

22. The LED lighting apparatus according to claim 1, further comprising a controller.

23. The LED lighting apparatus according to claim 22, wherein said controller comprises
at least one special purpose processor;
at least one low power processor; or
at least one computer processor.

24. The LED lighting apparatus according to claim 1, further comprising a diffuser at least one of inside, or outside of, the cover of the LED bulb.

25. The LED lighting apparatus according to claim 1, further comprising a reflector inside the LED bulb.

26. The LED lighting apparatus according to claim 1, further comprising at least one:
wherein said holding plate comprises a one-piece heat dissipation device where there is no space between the LED plate and said holding plate;
wherein said holding plate comprises a solid aluminum plate with no air gap, surrounding said LED plate; or
said holding plate comprises a solid aluminum plate with no air gap, surrounding said LED plate.

27. The LED lighting apparatus according to claim 1, wherein said LED plate is at or below a highest portion said holding plate, and touches said LED plate directly to facilitate directly dissipating heat.

28. The LED lighting apparatus according to claim 1, wherein the bulb is at least one of:
weatherproof; or
waterproof.

29. The LED lighting apparatus according to claim 1, further comprising at least one of:
wherein the cover reflects and directs light between 135-180 degrees without reflective material; or
a reflector to distribute light between a 135-180 degree angle.

30. The LED lighting apparatus according to claim 1, wherein the diffuser comprises a pyramid shaped plastic.

31. The LED lighting apparatus according to claim 1, wherein the reflector comprises:
an annular ring; and
a truncated cone coupled to said annular ring.

32. The LED lighting apparatus according to claim 31, wherein the reflector comprises a white plastic reflector.

33. The LED lighting apparatus according to claim 1, further comprising:
a housing.

34. The LED lighting apparatus according to claim 33, wherein said housing comprises at least one of:
a bell-shape or a cone-shape;
a plastic housing;
an aluminum housing;
a metallic housing;
a nonmetallic housing;
an alloy housing; or
wherein said housing encapsulates said power driver with said socket on a first end of said housing and said housing coupled on a second end to said holding plate.

35. The LED lighting apparatus according to claim 1, wherein the cover comprises at least one of:
glass;
plastic; or
silicone.

36. The LED lighting apparatus according to claim 1, wherein the holding plate comprises at least one of:
aluminum;
metallic alloy; or
metal.

37. The LED lighting apparatus according to claim 1, wherein an empty space below the LED plate inside the LED bulb is filled with silicone.

38. A method of making an LED lighting apparatus comprising:
filling an air pocket of an LED lighting apparatus with silicone rubber; and
allowing said silicone rubber to set.

39. A tube lighting apparatus comprising:
a tube;
at least one end piece, adapted to be coupled to one end of said tube, said at least one end piece comprising:
at least one electric socket; and
at least one power driver electrically coupled to said at least one electric socket;
a side plate, adapted to be coupled to an inner portion of said tube, wherein said side plate comprises at least one reflecting surface; and
a light emitting diode (LED) plate adapted to be coupled to said side plate, said LED plate comprising a planar surface comprising a plurality of LED elements, said plurality of LED elements electrically coupled to said power driver.
